(19) United States
(12) Patent Application Publication
(10) Pub. No.: US 2003/0163461 A1
(43) Pub. Date: Aug. 28, 2003

(54) Method and system for defining sets by querying relational data using a set definition language

(75) Inventors: Hakon Gudbjartsson, Reykjavik (IS); Thorvaldur S. Arnarson, Reykjavik (IS); Pavol Rovensky, Kopavogur (IS); Vilmundur Palmason, Mosfellsbaer (IS)

Correspondence Address: HAMILTON, BROOK, SMITH & REYNOLDS, P.C., 530 VIRGINIA ROAD, P.O. BOX 9133, CONCORD, MA, 01742-9133, US

(73) Assignee: deCODE genetics, ehf., Reykjavik (IS)

(21) Appl. No.: 10/356,365

(22) Filed: Jan. 30, 2003

Related U.S. Application Data
(60) Provisional application No. 60/355,158, filed on Feb. 8, 2002.
(60) Provisional application No. 60/356,559, filed on Feb. 12, 2002.

(51) Int. Cl. G06F 7/00

(52) U.S. Cl. 707/3

(57) ABSTRACT

The present invention relates to the usage pattern, commonly found in many software applications, of defining sets of objects based on object attributes. A specifically designed set-definition language for defining sets, called SDL, is described and a software system that implements this language efficiently on top of a standard relational database management system (RDMS) is presented. The unique features of the SDL language are the implicit constraints that are enforced on the relational data that belong to the objects. Unique to the SDL system is also the logical metadata of dimensions that enables the SDL system to enforce these constraints across relations. The SDL system utilizes several optimization techniques to enable efficient implementation on top of RDMS. Query composition tools are also described and facilitate the creation of SDL expressions.

### RELATED APPLICATION(S)

This application claims the benefit of U.S. Provisional Application No. 60/355,158, filed Feb. 8, 2002 and U.S. Provisional Application No. 60/356,559, filed Feb. 12, 2002.

The entire teachings of the above applications are incorporated herein by reference.

### BACKGROUND OF THE INVENTION

1. Field of the Invention

The present invention relates to the usage pattern, commonly found in many software applications, of defining sets of objects based on object attributes. A specifically designed set-definition language for defining sets, abbreviated SDL, is described as well as a software system that implements this language efficiently on top of standard relational database management systems (RDMS).

2. Description of Related Art

Without a doubt, the most common query language is the SQL language that is implemented in most relational database systems (RDMS). However, although SQL is a very powerful language it is too complex for many users because of its versatile nature and the need for the user to know the underlying data schema. The aim with the invention SDL language is to (i) define a language that is powerful enough to allow users to define sets based on multiple criterias, (ii) define a language easy to use, and (iii) define a language easier to learn than SQL which does not require the user to know the underlying data schema. Similar attempts have been made before, such as with the health-query-language (HQL see www.clinical-info.co.uk/miquest.htm), where instead of eliminating the need for schema knowledge, the schema was kept fixed, hence allowing for certain simplifications in the language as compared to SQL. Thus, HQL is considered simple enough such that the average medical doctor can use it for epidemiological studies. HQL is however both a language for defining patient sets and calculating statistics on those sets, whereas SDL leaves that task to more standard OLAP systems.

Another language or protocol with similar aim as SDL is the lightweight directory access protocol (LDAP). Common to them is the set-definition pattern, however, unlike SDL, LDAP also provides access control methods to its data. Recently there has also been large effort in defining XML query languages and work to map them into SQL. See Florescu, D. and D. Kossman, “A Performance Evaluation of Alternative Mapping Schemes for Storing XML Data in a Relational Database”, Technical Report, INRIA, France, May 1999. However, SDL is significantly different from all these languages.

### SUMMARY OF THE INVENTION

It is an object of the present invention to provide a simple and efficient method for defining sets of objects, where the information on the objects is represented as relational data. For this attempt, the present invention defines a new set-definition language, abbreviated SDL, and a system that creates sets of objects by evaluating statements written according to the SDL syntax. An important feature of the SDL language is that it results in very short expressions due to its unique nature of implicit constraints. It is a further objective of this invention to describe an implementation that is efficient with regard to statement execution time, easily integrated with most existing relational data stored in legacy databases and does not suffer from maintenance problems related to data schema evolution.

To achieve these objectives, the present invention provides a novel way of representing multiple and continuously evolving relations. Each registered relation is defined in terms of high-level dimensions and each dimension is an instance of a data domain. The use of the term dimension is common in OLAP systems where a single hyper-cube is defined by facts and two or more dimensions. Applicants extend the usage of dimensions by allowing a dimension to exist in more than one relation, each of which can be thought of as a hyper-cube. This is a very important step in order to enable enforcement of the implicit constraints across relations. In addition Applicants use domains to extend conventional data types such that they can represent higher-level logical types such as weight and height. This approach has the side benefit of enforcing higher level type checking and it allows data stored in relational database tables, data that was not originally intended for the SDL system, to be registered with the SDL such that it can be used in set definitions.

Furthermore, Applicants show a systematic approach for mapping the SDL statements to corresponding SQL statements based on a schema model. In addition, the present invention provides methods for rewriting an SDL expression in such a manner that the SDL expression can be translated into SQL statements that have efficient implementation, i.e. statements that allow for optimization within an SQL optimizer.

In a preferred environment, a computer method and apparatus for defining sets of data to be retrieved from a data store (e.g., database) comprise: an input component for providing a written representation of a desired data set in terms of dimensions and relation instances, the desired data set having a certain set type; and an assembly coupled to receive the written representation. In response to the written representation, the assembly implies constraints on relation instances or dimensions by the set type of the desired data set and/or a record operator. This implying of constraints enables length of the written representation to be minimized.

The written representation may include any combination of a disjunctive expression and a conjunctive expression. The assembly thus performs OR-distribution on disjunctive expressions and eliminates from disjunctive expressions, conjuncts with undefined binding variables. The assembly translates conjunctive expressions to respective SQL join terms and translates disjunctive expressions to respective SQL-union terms. Further, the assembly rewrites the disjunctive and/or conjunctive expressions such that the SQL union operator is applied after the SQL join terms are calculated. This results in a computationally faster implementation.

In accordance with one aspect of the present invention, the assembly automatically enforces a record-operator where an expression in the written representation without the record-operator is equivalent to the expression with the record-operator.

In accordance with another aspect, the written representation may include an IN-statement and a disjunctive expression in a nested set. In that case, the assembly applies OR-distribution within the nested set by treating the IN-statement effectively as a record-operator expression.

In one embodiment the data store has a native query engine. In turn, the assembly further translates the written representation into code for the native query engine in a manner such that the code is optimized for querying the data store.

In one embodiment, the written representation utilizes a certain symbol, such as a colon, to specify hierarchical constraints on dimensions.

The written representation may include any combination of AND and OR expressions. In response, the assembly optionally performs OR-distribution in a manner that results in expressions with different sets of dimensions. That is, if the conjuncts (AND expressions) inside a subject written representation have different sets of dimensions, the written representation is separated into multiple working expressions.

In accordance with another aspect, the assembly groups expressions from the written representation based on record operator constraint.

In one embodiment, the input component includes (i) an editor for composing written representations and (ii) a search engine for enabling user browsing of dimension values and relations of the data store. The search engine assists a user in composing desired written representations. In particular, the search engine provides graphical views of dimension hierarchies for user browsing. Further, the editor employs a user interface which supports drag and drop of dimensions and relation values in written representations being composed.

### BRIEF DESCRIPTION OF THE DRAWINGS

The foregoing and other objects, features and advantages of the invention will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is a block diagram illustrating an exemplary setup required to implement the preferred embodiment of the present invention. As shown, the system consists of harddisks, a computer with RDMS, a computer with the SDL server system, and a computer running the SDL client modules.

FIG. 2 is a block diagram illustrating how the SDL server takes a set definition as an input and returns as output the elements that belong to the defined set.

FIG. 3 is an example showing two relations with dimensions and their corresponding domains. For the enumerable domains GENDER and DATE, their corresponding attribute tables are shown. The values in the DATE domain have a hierarchy structure.

FIG. 4 is an illustration of how the SDL meta-data tables would represent the scenario in FIG. 3.

FIG. 5 is an example of how virtual relations are generated as views on the underlying data in the repository based on the SDL query.

FIG. 6 is an example of data denormalization and corresponding metadata.

FIG. 7 is a block diagram describing the process for creating the virtual relations that are needed to evaluate each expression.

FIG. 8 is a block diagram describing the process for translating a conjunctive sub-expression with one or more negations.

FIG. 9 is a simplified diagram that describes the process for translating disjunctive and conjunctive expressions.

FIG. 10 is an overview of parser steps in one embodiment of the optimization and translation procedure from SDL to SQL.

FIG. 11 is an overview of the view-union optimization.

FIGS. 12A-12B illustrate a composite data explorer and query composer.

FIGS. 13A-13B illustrate relation detection assistance in the composite query-tool.

FIG. 14A-14B illustrate SDL keyword and dimension assistance.

FIG. 15A-15B illustrate SDL queries and set analysis using a Venn-tool.

FIG. 16A-16B illustrate output-specification for a report on the sets.

FIG. 17A-17B illustrate further the output-specification of FIG. 16.

FIG. 18A-18B illustrate SDL query dialogs.

### DETAILED DESCRIPTION OF THE INVENTION

The following description of the preferred embodiment is to be understood as only one of many possible embodiments allowed by the scope of the present invention. Reference is made to the accompanying figures that form a part hereof.

Overview

A complete SDL system setup is a combination of client and server modules that can be utilized to build software applications that allow users to evaluate arbitrary SDL queries in an easy manner. The SDL invention described here covers both the server part of the system as well as the software components to facilitate the creation of SDL queries, either with a specific SDL editor or through specialized SDL query dialogs. Applicants also briefly describe utilities for importing data and for the maintenance of the SDL meta-data.

In order to understand the importance of a simple, yet powerful set definition language, consider the case where a computer user is searching for files in the operating system that have some properties. Although not thought of as such, this use case is an example of a pattern where a user is defining a set of objects, e.g. files. Also, consider the scenarios where a user needs to define sets of affected individuals, for genetic linkage analysis, based on medical events such as diagnosis, treatments and measurements. Also, consider the selection of a set of genes that have certain properties represented with attributes associated to them. Yet another example could be the selection of genetic markers to be used for genetic analysis or the selection of archived linkage-runs, stored in a database with relevant search attributes associated to them. All these use-cases are examples of where the definition of a “set” is in common.

A very important design objective with the SDL language was to create a language that could be implemented efficiently, both with respect to query response time and data volumes. Indeed, the preferred embodiment of the SDL query system is implemented in such a way that SDL statements are parsed and translated into SQL-statements and evaluated in a RDMS. Not only does this simplify the SDL compilation and evaluation logic, but also it allows one to utilize the enormous effort that has gone into optimizing queries and the manipulation of large data volumes in RDMS. Similar approaches have been used before in other language implementations, e.g. in LDAP and XML query language applications.

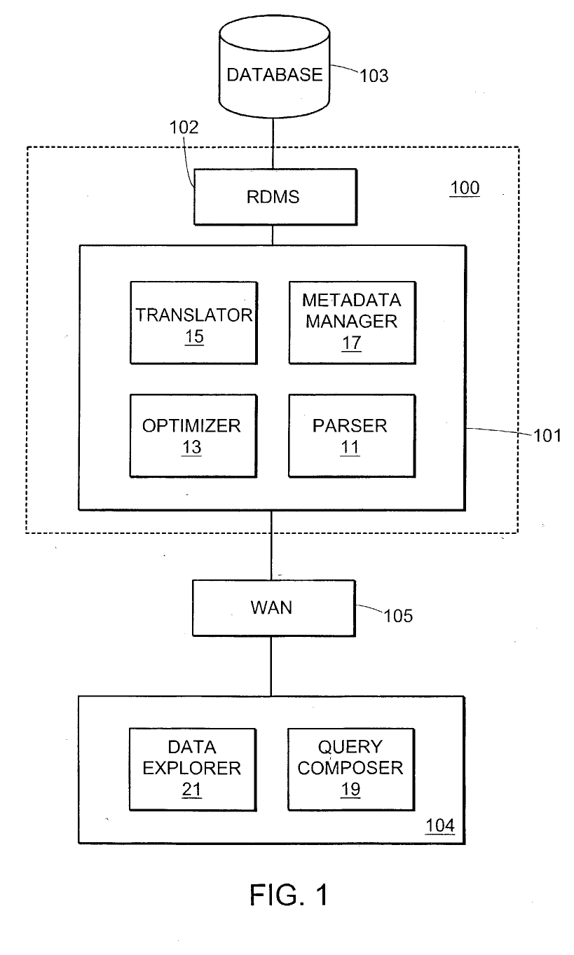

As shown in FIG. 1, The SDL server system 100 consists of several components 101. In the preferred embodiment the components 101 include a parser 11, optimizer 13, translator 15 (preferably SDL2SQL translator), evaluator and data and meta-data modules 17. In the preferred embodiment, the SDL server is also comprised of an RDMS (Related Database Management System) 102 and harddisks 103 for the storage of the data. It is a matter of configuration whether RDMS 102 and components 101 reside in the same computer or whether they are kept on different computers. The server 100 is then connected to an SDL client 104 through a wide area or similar network 105. The client 104 can either be an application specifically designed for SDL or a SDL query component bundled into a host application. Generally client 104 is formed of a query composer 19 and a search engine 21 of sorts.

The rest of the text describes the nature of the SDL language, logical constructs such as dimensions and domains, relational schemas as well as mapping of the language to the SQL language. Further, later described are special SDL query tools that facilitate the construction of SDL expressions.

Introduction to SDL

The best way to understand the SDL language is by taking many short examples. Along the way Applicants introduce the concepts necessary for understanding the composition of a general SDL query. A general SDL query declaration looks almost like the way sets are defined with standard mathematical notation:

setname={output-dimension|SDL-expression}

Where, “setname” is the name of the set that is being defined and “SDL-expression” is an expression of first-order logic that has to be true for every element in the set. The set is defined over the output-dimension. The SDL language is in many ways similar to relational calculus (see R. Ramakrishnan and J. Gehrke, “Database Management Systems,” 2nd ed., McGraw Hill, 2000), especially domain relational calculus (DRC). Both of these languages are for instance unsafe as defined by Ramakrishnan and Gehrke. The main difference is that in the SDL language, dimensions are used as compared to domain variables in DRC. Therefore referrals to relations in SDL are unnecessary. Also, in SDL the output-dimension is always implicit in the SDL-expression, i.e. other dimensions have to appear in relations with the output-dimension and a natural-join on the output-dimension is implemented behind the scenes. This results in very sparse expressions that are easily human readable. Typically the output-dimension is an identifier of some objects that can then later be used to retrieve additional information on those objects that were in the set that was being defined.

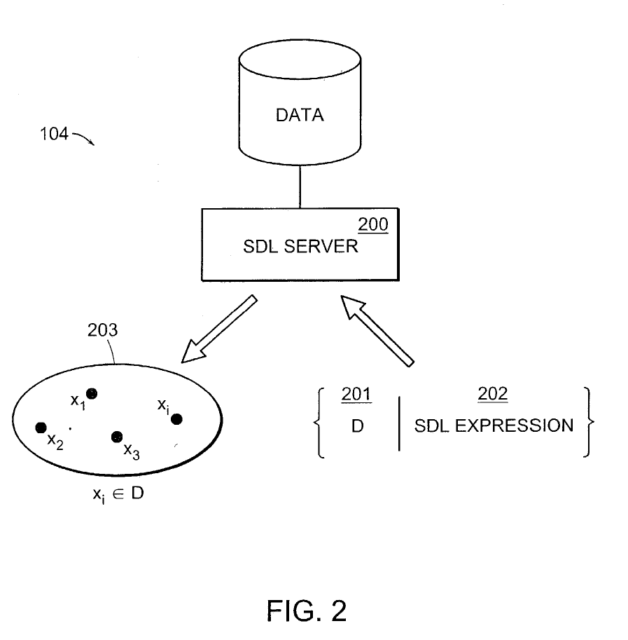

FIG. 2 shows how an SDL statement is sent to an SDL server 200 from client 104. The statement is comprised of the output-dimension D 201 and an SDL expression 202. The server 200 returns a set 203 with elements xᵢ from the output-dimension (i.e., xᵢ εD). For each element xᵢ there must exist relation instances in the data with the output-dimension D and other dimensions referred to in input expression 202 such that the expression in 202 is true for each element xᵢ in the output set 203.

An example that brings this into clinical context is the following:

patients={pid|dob>1966 AND [diag:icd9.stroke AND date>2000[}

Here, patients become the set of all personal identification numbers (pid) of individuals who were born after 1966 and have been diagnosed with a stroke after the year 2000. The proper way to read this example set definition is that “patients defines the set of all individuals for which there exists a date of birth attribute larger than 1966 and for which there exists a data record/relation with the attributes diag:icd9.stroke and a date larger than 2000.” In addition to the output-dimension of pid, the dimensions that appear in this definition are dob, diag and date. Note the use of the colon in “diag:icd9.stroke” which is equivalent to “diag=icd9.stroke.” This syntax is allowed for dimensions such as diag that are of a domain type that is enumerable and has a hierarchy associated with it. For such dimensions, this is a short hand notation for the SQL constraint “diag LIKE ‘icd9.stroke.%’ OR diag=‘icd9.stroke’”, i.e. all diagnoses that are leaves in the corresponding diagnostic code hierarchy. The square brackets denote the so-called record-operator, used to enforce the co-existence of one or more attributes in the same record/relation. Since the same individual can have multiple diagnoses it is not uncommon to record them in relation with a date. However, certain attributes, such as date of birth, are each a singleton by nature and therefore typically only registered once per individual.

Another SDL expression example from the biology field is as follows:

target genes={gene-id|geneclass:gpcr AND {expr.tissue:brain; $x=expr.level] AND [expr.tissue:stomach AND 1.5*expr.level<$x]}

Based on this definition, the set “target-genes” will contain all gene-ids of GPCRs that are expressed 50% more in brain tissue than in stomach tissue. Note the use of binding variables within the record expressions to enforce the expression level in some brain tissue to be 50% higher than any expression level in stomach tissue. One sees that the output dimension, i.e. the identifier of the elements that represent the sets, does not appear in the SDL expression itself. Once the set type has been specified, it is implicit in the SDL expression that all of the other dimensions used refer to attributes associated with the output dimension. This is one of the unique features of the SDL syntax and results in very short expressions. In the first example, the existence of the relations (pid,dob) and (pid,diag,date) is assumed, and in the second example the existence of relations (gene-id,class) and (gene-id,expr.tissue,expr.level) is assumed.

The SDL system can be configured in such a manner that the output dimension has been preset, i.e. the SDL server 100, 200 returns only a single type of set, for instance sets of individuals, genes, markers etc. Thus, the user usually only has to create the “SDL expression” part itself, and does not have to specify the “output-dimension” and the curly-brackets in the SDL query; and the SDL query tool will generate an output set of the appropriate type. However, an SDL system can also be set up in such a manner that it allows definition of various types of objects. Furthermore, it is within the purview of those skilled in the field to extend the invention language (SDL) in such a manner that it allows the definition of relation with multiple output-dimensions.

Domains, dimensions and relations

Without going into a formal syntax specification, Applicants next briefly consider the structure of a general SDL expression. Without a loss of generality, assume an SDL system 100 (FIG. 1) is configured to generate sets of individuals (pid-s) based on longitudinal medical event data registered on those individuals. The general format of patient data imported into the SDL system 100 is therefore of the following relational form:

relation=(output-dim , dim1, . . . , dimN)=(pid, A1, . . . ,An)

For data to be directly applicable to set definition in SDL, the output dimension has to appear in the data relations (here it is pid). The other elements (representing respective columns in a data store 103) that appear in the relation statement and represent one or more attributes associated with the individual, have to be of pre-specified dimensions. Thus, dimensions can be considered as attributes or terms associated with individuals through data relations. If data is normalized in such a way that the output-dimension is not present, it can still be used through the use of nested sets. Nested sets and the registration of normalized data are discussed later in more detail.

For each dimension, a domain has to be specified. Not only does the domain specify the data type used to represent its corresponding dimensions in the RDMS 102, but it also specifies the logical content and constraints associated with its corresponding dimensions. For instance, the domain may specify whether the corresponding dimension is “closed” (enumerable) or “open” and whether there are maximum and minimum limitations. As an example, consider attributes such as weight and height. Both are naturally represented by a NUMBER, however, their values represent totally different physical measures. Therefore, two separate domains should be used to represent values of weight and height, and two dimensions from the different domains should not be comparable. Hence, the domains can be used to enforce strict type checking. As another example consider the dimensions “date of birth” and “date of death”. Although these dimensions represent two different attributes, they have still the same logical type and are therefore naturally two instances of the same domain, i.e. date. In summary, dimensions represent attributes that are instances of a certain domain, and dimensions that are instances of the same domains are comparable. When a domain is defined as closed, its values (corresponding dimensions) can optionally be organized into a hierarchy.

Dimensions must have distinct names. Their names can be organized in a hierarchical manner (folders) such that the path-name represents the distinct name of the dimension. In such case, they are typically placed in the hierarchy based on their logical meaning. As a systematic approach, in order to register a relational schema with multiple tables into the SDL system 100, the dimensions could be named following the format “table_name.domain”. However, dimensions that represent ids (identifiers) of objects that are supposed to be in the SDL sets have to map with the same name for each table.

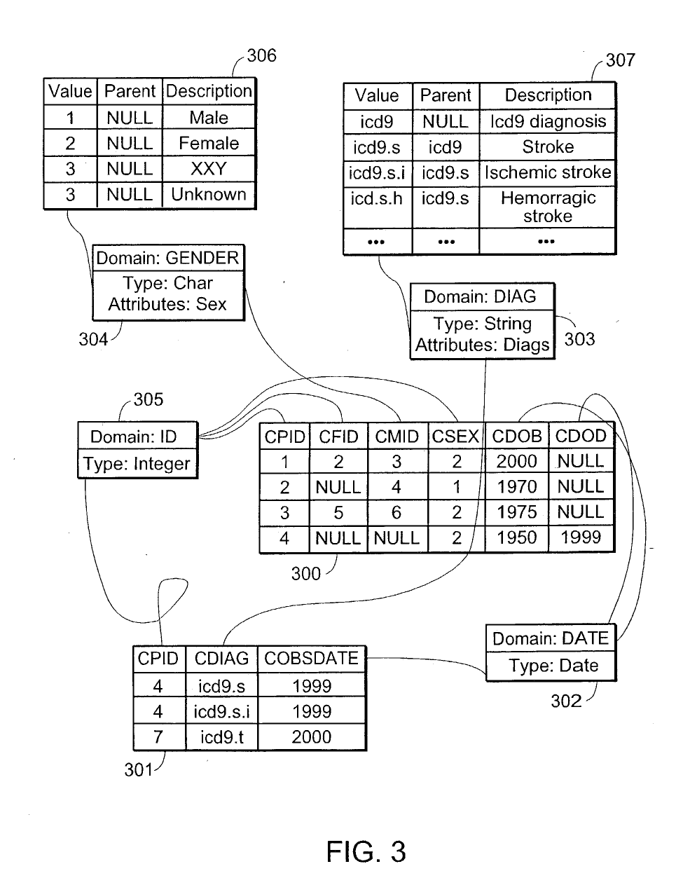

FIG. 3 shows an example of two relations, 300 and 301, and four different domains, 303, 304, 305 and 302. Relation 300 has six dimensions, namely CPID, CFID, CMID, CSEX, CDOB and CDOD. Relation 301 has three dimensions—CPID, CDIAG and COBS DATE. Two of the domains 303, 304 (diagnosis and gender, respectively) in this example are enumerable and therefore have associated with them tables 306, 307 that list the possible values in the domains, 304 and 303. Diagnosis Domain 303 table 307 has a hierarchial nature, however, gender domain 304 table 306 is a special case of a “flat” diagnosis hierarchy. The other domains, identifier domain 305 and date domain 302, are open domains that do not have tables that list the possible values associated with them. Both relations 300 and 301 have the dimension PID (in column CPID). Also, relation 300 has three different dimensions (CPID, CFID and CMID) that belong to the same domain, i.e. Identifier Domain 305.

Tables and metadata

Available relations in an SDL repository are completely defined by the data that has been imported or registered with the system. A relation is very much like an SQL database table but the columns do not bear names as such, rather each column is bound to a specific dimension. Each dimension may appear in an arbitrary number of relations. The dimension may be thought of as a super column able to span an arbitrary number of tables. The SDL language defines sets of objects that depend on the output-dimension in the set definition based on relations registered with the SDL system 100. The SDL language neither specifies how expressions are evaluated nor the storage mechanism for the relations. When RDMS 102 (FIG. 1) is used for the embodiment of the system, two extreme data-schemas can be used for the storage of relations. Both of these schemes set no limits to the number of relations allowed. One approach is the so-called horizontal structure, i.e. a large table with sufficient number of columns to store all the combinations of dimensions that can coexist together. The other extreme alternative is the vertical representation or a fully pivoted storage format (see R. Agrawal et al., “Storage and Querying of E-Commerce Data,” Proceedings of the 27th VLDB Conference, Rome Italy, 2001) that has recently been proposed as a storage mechanism for data where there are very many multiple different relations. In the vertical schema, all relations are put into a single table that has only three columns, i.e. rowid, dimension, and value.

Other alternatives have also been proposed for schemas that are allowed to evolve, such as to store the relations in multiple 2-ary tables (see S. Shi et al, “An enterprise directory solution with DB2”, IBM Systems Journal, 39(2): 360-383, 2000; M. Missikoff, “A domain based internal schema for relational database machines”, In Proceedings of the 1982 ACM SIGMOD International Conference on Management of Data, Orlando, Fla., June 2-4, 1982, pg. 215-224; G. P. Copeland and S. N. Khoshafian, “A decomposition storage model”, In Proceedings of the 1985 ACM SIGMOD International Conference on Management of Data, Austin, Tex., May 28-31, 1985, pg. 268-279; and S. Khoshafian et al., “A query processing strategy for the decomposed storage model”, In Proceedings of the Third International Conference on Data Engineering, Feb. 3-5, 1987, Los Angeles, Calif., USA, pg. 636-643).

The present invention proposes a new alternative that is closer to regular relational schemas used in most RDMS. Applicants' approach is to store information on all the dimensions that have been defined in the system 100, their domain and the relations they exist in. The preferred embodiment defines the following meta data tables (at 17 in FIG. 1) to store information on domains, dimensions and relations:

domains(domain, SQLtype, SQLattributehierarchy)

dim2dom(dimension, domain)

relations(relation, SQLrelation, inclusion_criteria)

dim2rel(dimension, relation, column_name, multiplicity)

These four SQL tables define a basic metadata structure for the invention SDL server system 100. One embodiment omits data types on the columns in these tables and effectively assumes column contents to be strings (e.g. VARCHAR2 in Oracle RDMS).

The table named “domains” stores a domain name and the SQL data type used for columns belonging to dimensions defined on its domain. For domains that are enumerable and closed, it also stores reference to a table listing all the allowed values in a hierarchical manner (the hierarchy can also be flat). Optionally, minimum and maximum values can be used to specify an allowed range for open domains.

The table “dim2dom” stores indications of the connections between dimensions and their corresponding domain. The table named “relations” indicates connections between SDL relation and corresponding SQL structure for representing that relation. The SQL structure can either be a table, view or materialized view. For each relation, an inclusion criteria can be specified, i.e. a condition on the selected dimensions that needs to be met for the table to be included into the SQL code (see the following discussion). Formally, Applicants' use of relation is more like a set of relation instances since the same SDL relation can exist in more than one SQL relation. This will become clearer later.

Finally, the table “dim2rel” indicates the connection between the dimensions and the relations (set of relation instances) and indicates the column used to store the dimension in the corresponding table. The last column stores information on whether duplicates are allowed in the dimension in the corresponding relation.

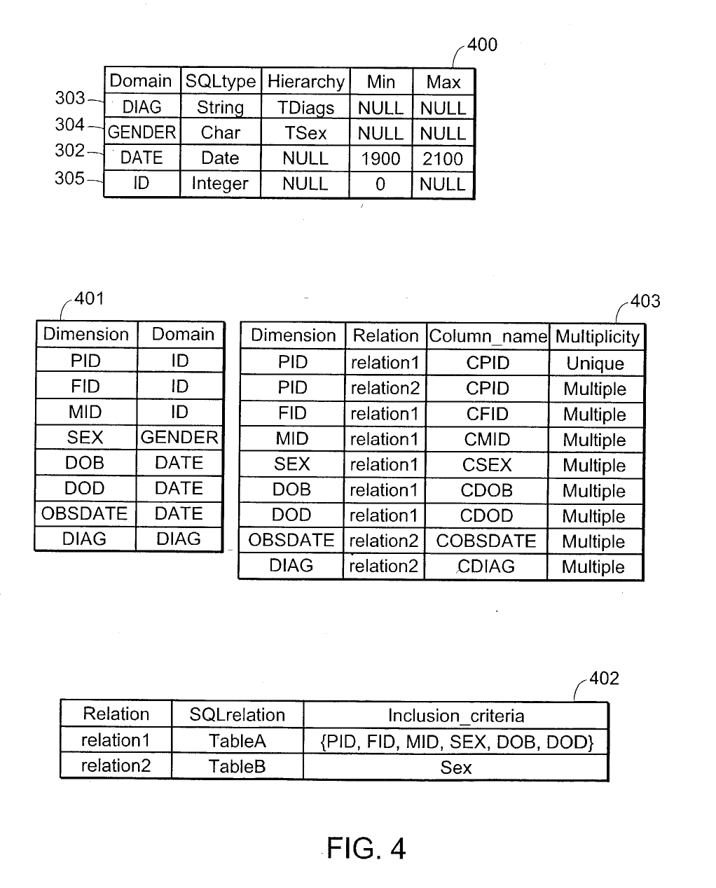

FIG. 4 shows how the meta data tables 17 mentioned above, would be instantiated for the example relations 301, 302 of FIG. 3. In that example, domains table 400 specifies the four domains (Diagnosis 303, gender 304, date 302 and identifier 305) and their respective SQL type (string, character, date, integer, respectfully). Domains table 400 makes reference (“Tdiags”, “Tsex”) to enumeration tables 306, 307 for the closed domains 303, 304 and indicates maximum and/or minimum values for the open domains 302, 305. Dim2dom table 401 indicates the domain.

Referring back to FIG. 1, the SDL server 100 uses its metadata tables (collectively illustrated at 17) to parse (at parser 11) an SDL expression and translate it (via translator 15) into a corresponding SQL statement that refers to the appropriate tables that are needed for proper evaluation of the subject expression. This is best explained through a short example.

Consider the following SDL expression: {d0|d1=2}. Here d0 is the output-dimension and the constraint is set on dimension d1. This expression should return all values of d0 that exist in relation with d1 where d1=2. Expressed in relational algebra, the following is equivalent:

{d0|d1=2}=II_{do} (σ_{d1=2} (d0, d1)))

To evaluate this expression, the invention SDL system 100 uses the table dim2rel (like 403 of FIG. 4) to look up all relations that contain the dimensions d0 and all the relations that contain the dimension d1. Two sets of relations result, i.e., one for each of d0 and d1. Next the invention SDL system 100 takes the intersection of these two sets of relations. The set resulting from the intersection can contain one or more relation name. The system 100 then creates a virtual relation that is a projection of the two dimensions in the union of all the relations it found with the intersection operation (i.e. union of sets of relations instances). This virtual relation is denoted “v01”, the numbers representing the dimensions that exist in it.

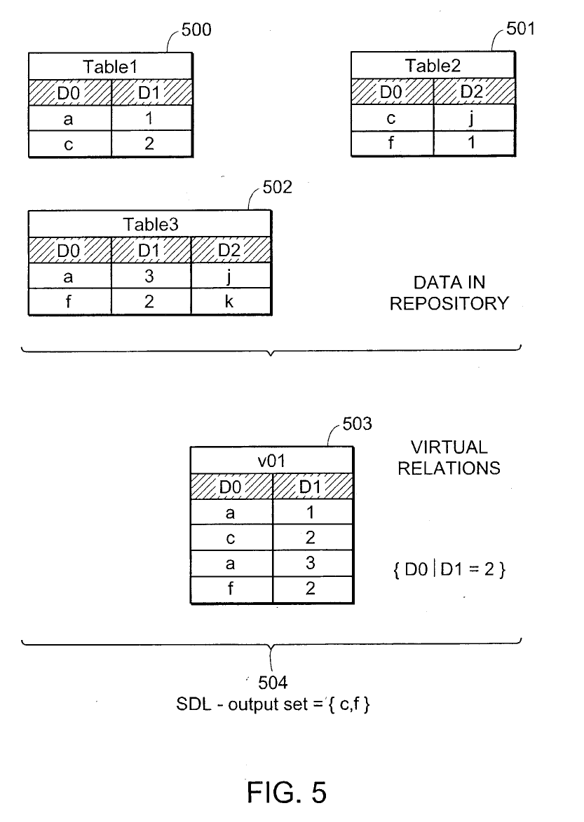

Let's assume that there are only three tables registered with the SDL server 100 as shown in FIG. 5: table1(d0,d1) 500, table2(d0,d2) 501, and table3(d0,d1,d2) 502. For simplicity of the example, assume that the column names of the tables are the same as the name of the dimensions they store. This is not a requirement, it is just for purposes of illustration in the example. The SQL code that evaluates the previous SDL expression is then:

SELECT DISTINCT DO FROM (SELECT V01.D0 D0 FROM (SELECT D0, D1 FROM TABLE1 UNION SELECT D0, D1 FROM TABLE3) V01 WHERE V01.D1=2);

Notice how the virtual relation v01 503 only contains table1 and table3 since table2 doesn't contain dimension d1. With respect to an SQL implementation, v01 could also have been defined as a view, instead of being defined on the fly as above:

CREATE VIEW V01 (D0,D1) AS

(SELECT D0, D1 FROM TABLE1 UNION SELECT D0, D1 FROM TABLE3);

SELECT DISTINCT D0 FROM (SELECT V01.D0 D0 FROM V01 WHERE V01.D1=2);

If the registered data consists of the tables 500, 501, and 502, the result from both of these SQL statements shown above would be the set {c, f} 504.

Consider another more complicated example with a record operator:

{d0|d1=2 AND [d3>0 AND d4<0]}=II_{d0} (σ_{d0=d0} [symbol] (σ_{d1=2} ((d0,d1))×σ_{d3>0, d4<0} ((d0 [symbol] , d3, d4)))) In order to evaluate this expression, the SDL system 100 creates two virtual relations, v01 and v034 and performs a natural join on d0 (the prime is just used to make a distinction between the same dimension coming from two different relations).

In the following discussion on translation of SDL to SQL statements, the virtual relations are denoted with “v” and a suffix based on the dimensions that are included in the corresponding relation. For instance, a relation with d0, d1 and d3 is denoted by v013. The following will leave aside whether the virtual relation is defined on the fly or with SQL views since it does not impact other things in the SQL statement structure.

Normalization and views

Schema refinement through normalization of data is a common practice in relational schema designs and there exists extensive literature on this subject (see R. Agrawal et al., “Storage and Querying of E-Commerce Data”, Proceedings of the 27th VLDB Conference, Rome, Italy, 2001 (p. 417)). The basic idea is to format the data such that updates are easy, the data is flexible with respect to queries, and storage space is minimum. The invention SDL system 100 utilizes normalized data in two ways: directly, through the use of nested sets, and indirectly through the use of views. Here a closer look at the former approach is taken since, due to limitations in most SQL optimizers, it requires a special flag in the metadata in order to be implemented efficiently.

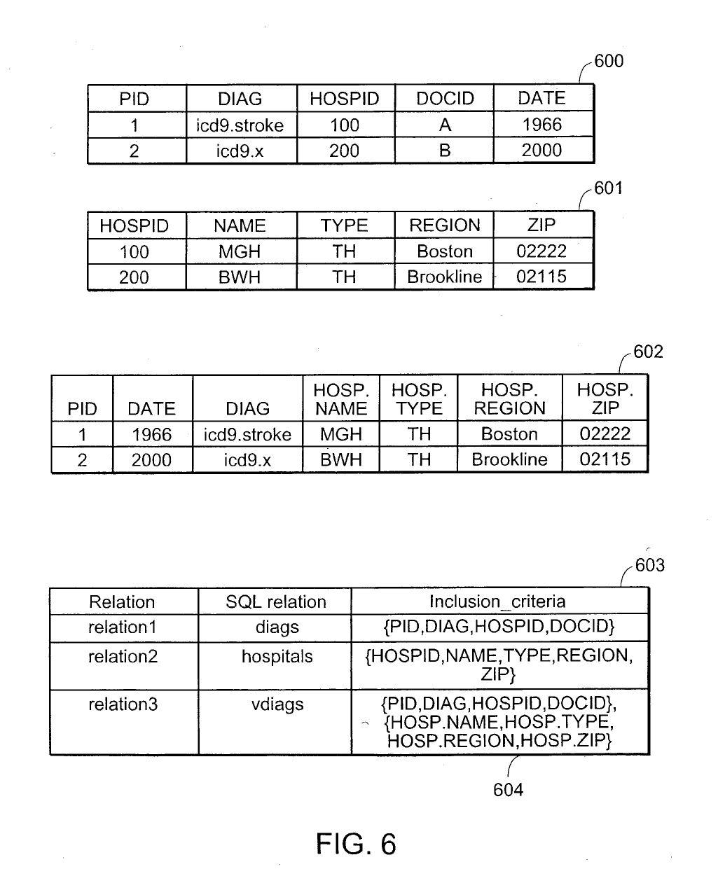

Without loss of generality, consider an arbitrary scenario where one has two relations as shown in FIG. 6, diags(pid,diag,hospid,docid,date) 600 and hospitals(hospid,name,type,region,zip) 601. If one would like to define a set of all patients that have gotten some diagnosis in a hospital in a particular region, the corresponding invention SDL expression could look like:

{pid|[diag=icd9.x AND hospid IN {hospid|zip=101}]}This expression is perfectly fine, however, it can be argued that it is relatively long and complex for most inexperienced users. One might like to define new dimensions on the diagnoses that make this definition easier. One could for instance create a view 602 called vdiags and register it in addition to diags 600 and hospitals 601: vdiags(pid,diag,hosp.name,hosp.type,hosp.region,hosp.zip,doc.speciality,doc.age,date) with the following SQL code:

CREATE VIEW VDIAGS AS (SELECT PID,DIAG,HOSP.NAME,HOSP.TYPE,HOSP.REGION,HOSP.ZIP,DATE FROM DIAGS, HOSPITALS HOSP WHERE DIAGS.HOSPID=HOPS.HOSPID);

With these dimensions, the subject SDL expression would simply become:

{pid|[diag=icd9.x AND hosp.zip=101]}

This expression is obviously much shorter and easier to understand than the one above (hosp.zip could also have been called diag.zip).

There is a dangerous pitfall however. Notice what happens if one creates an expression such as:

{pid|diag=icd9.x}

As discussed above, this expression will generate a virtual relation that is a union of diags 600 and vdiags 602, since both of these tables contain the dimensions pid and diag. All the information on the relation (pid,diag) is in diags 600, and vdiags 602, adds no additional information given its definition. What is even worse is that the SQL code that would be generated (see the following discussion on the translation of SDL to SQL) would use the view vdiags 602 with no conditions on the dimensions taken from hospitals 601. Hence, this would result in a cross-product (Cartesian product) between the tuples in diags, 600 and hospitals 601, a join that could potentially be very expensive. This is because most SQL optimizers do not recognize that this join does not have to be performed, given the output parameters and the conditions specified in the SQL join.

Applicants' solution to the above problem is not to abandon views, but to allow them to be registered into the SDL system 100 with additional information on their inclusion criteria. The inclusion criteria can be implemented in many was. For instance as a list of sets of dimensions with the meaning that one dimension from each set is required to appear in an expression or record-expression (see the syntax specification) for the table/relation to be included into the virtual relation. As an example, Applicants could have specified the inclusion criteria on vidags in the metadata table relations 603 as 604: {pid, diag, hospid, docid, date}, {hosp.name, hosp.type, hosp.region, hosp.zip}. Then the view would only be included into the virtual view when there is at least one column required from each of the two tables, diags 600 and hospitals 601. A query that uses dimensions from both of the underlying tables, diags 600 and hospitals 601, would however only use the view 602, vdiags, since the inclusion criteria would be false for the two tables.

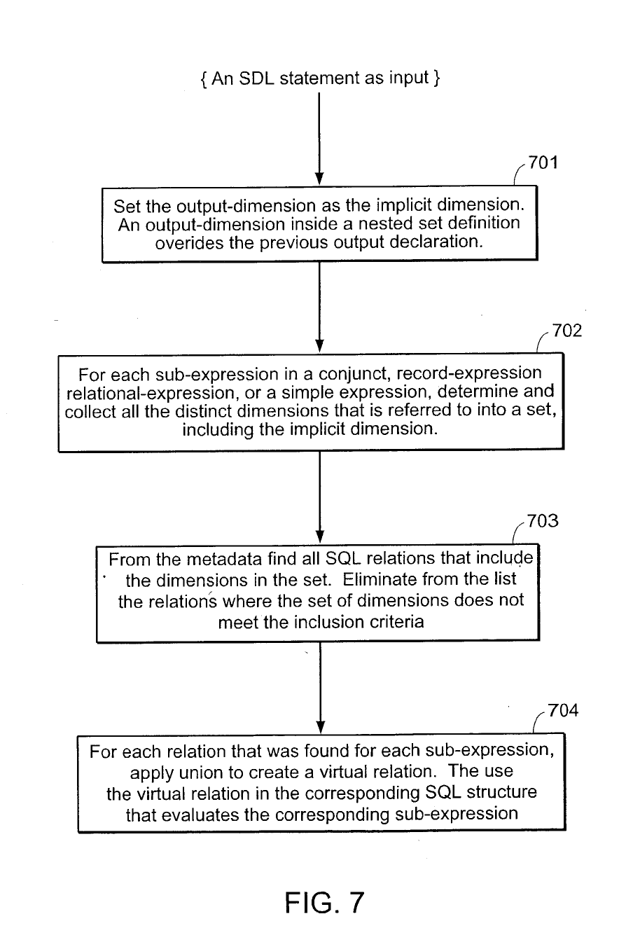

In general, the inclusion criterias will result in fewer SQL relations that will be included into the SQL statement. FIG. 7 summarizes the process of finding which SQL relations are needed in a virtual relation for an SQL statement that results from the translation of SDL to SQL. An SDL statement is provided as input. At step 701, the system sets the output dimension as the implicit dimension. An output dimension inside a nested set definition overrides the previous output declaration.

Next in step 702, for each sub expression in a conjunct record-expression, relational-expression, or a simple expression, the system determines and collects all the distinct dimensions that are referred to into a set. The system includes the implicit dimensions.

In step 703, the system finds from the metadata and lists all the SQL relations that include the dimensions in the set created in step 702. The system eliminates from the list the relations where the set of dimensions does not meet the inclusion criteria.

In step 704, for each relation that was found in step 703 for each sub-expression, the system applies a union operation to create a virtual relation. The system then uses the virtual relation in the corresponding SQL structure that evaluates the corresponding sub-expression.

It is worth mentioning that star-schemas by William A. Giovinazzo, “Object-Oriented Data Warehouse Design: Building a Star Schema”, Prentice Hall, (February 2000) and Oracle 9i—“Data Warehousing Guide”,(Part Number A90237-01), June 2001, Oracle Corporation—www.oracle.com are common examples of where data is denormalized. A star usually refers to a fact-table with corresponding dimension-tables. The fact-table usually stores facts that are some kind of measures, e.g. cost, and dimension columns that are classifiers on the measure (attributes). The dimension-tables are then composed of a dimension column that has a foreign-key relationship with a dimension column in the fact-table in addition to more columns that are usually lower-resolution classification of the dimension, e.g. timestamp grouped into weeks, months, quarters and years. In the terminology presented herein, Applicants do not make any distinction between facts and dimensions as such, although, dimensions would typically be dimensions that belong to enumerable domains. Applicants have described that the SDL metadata 17 provides special support for enumerable domains that have hierarchical values. The SDL metadata 17 could also be augmented in such a manner that domains could be assigned dimension-tables, i.e. dimension grouping tables. This could for instance be obtained by adding fields in the domain table, see 400 in FIG. 4. The benefit of this could be that the SDL system could automatically provide the grouping that the dimensions-table provides to any dimension that belongs to the corresponding domain.

As an example consider the import of registration of a relation that has a dimension with a date dimension that is an instance of the domain DATE. If a dimensions-table, dategr(date,week,month,qt,year), had been assigned to the DATE domain, the SDL system could automatically create, in addition to the date dimension, a dimension such as date.week, date.month, date.qt, date.year and register a view (or materialized view) that is a join between the imported relation and the dimension-table. This would provide the user with “hierarchical-like feeling” for all dimensions of such domains, when creating an expression with a constraint on time.

Translation of SDL to SQL

To explain how a general SDL statement can be translated to a SQL statement, this discussion uses a stepwise approach and starts by explaining how the basic SDL structures map to SQL. For one skilled in the art of compilers and RDMS, it will then follow how to construct a generic translator/compiler 15 that takes a general SDL statement which complies with the SDL syntax specification and maps it to an SQL statement. The SQL standard is defined by ANSI document, X3.135-1992, “Database Language SQL” and in revised form by document ANSI/ISO/EIS 9075. These documents are available from the American National Standards Institute.

Atomic expression

Consider the most simplistic definition of an SDL set as:

{d0|d1}

Here d0 is the output-dimension, i.e. the set is defined on dimension d0. This SDL definition is translated into the following SQL:

SELECT DISTINCT DO FROM (SELECT V01.D0 D0 FROM V01 WHERE V01.D1 !=NULL);

where v01 is defined as a view of all relations with dimensions d0 and d1, i.e. (d0,d1). Since d0 is the output-dimension, according to the SDL syntax, a specific (or target) dimension for the output does not have to be mentioned in the expression itself.

Constraints and comparisons

SDL expressions with relational-expression and calc-expr are translated in the following manner:

{d0|d1>pi}

is translated to:

SELECT DISTINCT D0 FROM (SELECT V01.D0 D0 FROM V01 WHERE V01.D1>PI);

{d0|d1 !=pi}

is translated to:

SELECT DISTINCT D0 FROM (SELECT V01.D0 D0 FROM V01 WHERE V01.D1 !=PI);

Two dimensions with the same domain type can be compared in the following manner:

{d0|d1>d2}

This is translated to:

SELECT DISTINCT D0 FROM (SELECT V01..D0 D0 FROM V01, V02 WHERE V01.D0=V02.D0 AND V01.D1>V02.D2);

Notice that since no record-operator (see below) is used the tuples with d1 and d2 do not have to come from the same relation. The same is the case with in this calculated expression:

{d0|d1/d2>10}

which is translated to:

SELECT DISTINCT D0 FROM (SELECT V01.D0 D0 FROM V01, V02 WHERE V01.D0=V02.D0 AND V01.D1/V02.D2>10);

Conjunctive expression

{d0|d1>pi AND d2=4}

is translated to:

SELECT DISTINCT D0 FROM (SELECT V01.D0 D0 FROM V01, V02 WHERE V01.D0=V02.D0 AND V01.D1>PI AND V02.D2=4);

Disjunctive expression

{d0|d1>pi OR d2=4}

is translated to:

SELECT DISTINCT D0 FROM (SELECT V01.D0 D0 FROM V01 WHERE V01.D1>PI UNION ALL (SELECT V02.D0 D0 FROM V02 WHERE V02.D2=4));

Record-operator

{d0|[d1>pi AND d2 !=4]}

is translated to:

SELECT DISTINCT D0 FROM (SELECT V012.D0 D0 FROM V012 WHERE V012.D1>PI AND V012.D2 !=4);

Like before, v012 defines a view of all relations with dimensions d0, d1, and d2. The previous SDL expression could also have been written in this way:

{d0|[d1>pi AND NOT d2=4]}

and it is translated to:

SELECT DISTINCT D0 FROM (SELECT V012.D0 D0 FROM V012 WHERE V012.D1>PI AND NOT V012.D2=4);

Notice the equivalence of NOT and “!=” inside the record-expression. The meaning of NOT outside record-expressions is different as described next.

Consider now two examples that use relational-expression and calc-expr inside the record-operator and contrast them with the examples shown previously. Two dimensions with the same domain type can be compared in the following manner:

{d0|[d1>d2]}

This is translated to:

SELECT DISTINCT D0 FROM (SELECT V012.D0 D0 FROM V012 WHERE V012.D1>V012.D2);

Notice that since a record-operator is used, the tuples with d1 and d2 have to come from the same relation. The same is the case with in this calculated expression:

{d0|[d1/d2>10]}which is translated to:

SELECT DISTINCT D0 FROM (SELECT V01.D0 D0 FROM V012 WHERE V012.D1>V012.D2);

Negations

Before considering the general case of expressions with NOT, start by considering two simple cases:

{d0|d1>pi AND NOT d2=4}

is translated to:

SELECT DISTINCT D0 FROM SELECT V01.D0 D0 FROM V01 WHERE V01.D1>PI MINUS (SELECT V02.D0 D0 FROM V02 WHERE V02.D2=4));

Consider now the simpler case where there is only the NOT term in the expression:

{d0|NOT d1>pi}

Now it seems impossible to use the set-minus approach shown above. However, by recognizing that since d0 is the output dimension, it is implicit in the constraint and therefore this set definition is equivalent to:

{d0|d0 AND NOT d1>pi}

and can therefore be translated to:

SELECT DISTINCT D0 FROM SELECT V0.D0 D0 FROM V0 WHERE V0.D0 !=NULL MINUS (SELECT V01.D0 D0 FROM V01 WHERE V01.D1>PI));

Here v0 denotes a view containing all relations with d0. Applicants like to refer to v0 as the “universe” or all the attributes that the dimension d0 covers in its corresponding domain.

It should be mentioned that the inclusion-criteria, e.g. 604 in FIG. 6, on relations can be used to control which SQL-relations will be included in the virtual relation that constitutes the “universe”.

Now consider a record-expression with NOT:

d0 d3=7 AND NOT [d1>pi AND NOT d2=4]}

It is translated to:

SELECT DISTINCT D0 FROM (SELECT V03.D0 D0 FROM V03 WHERE V03.D3=7 MINUS (SELECT V012.D0 D0 FROM V012 WHERE V012.D1>PI AND NOT V012.D2=4));

Like before, v012 defines a view of all relations with dimensions d0, d1, and d2.

Binding variables

Binding variables can be used in conjunction with records, e.g.:

{d0|[d1=a; $x=d2] AND [d1=b AND d2>$x]}

This definition is translated to:

SELECT DISTINCT D0 FROM (SELECT VA.D0 D0 FROM V012 VA, V012 VB WHERE VA.D0=VB.D0 AND VA.D1=A AND VB.D1=B AND VB.D2>VA.D2);

Notice how the criteria with the binding variable are implemented using additional constraints on the join, which in this case is a self-join.

Binding variable and negation

Binding variables can be used in conjunction with records, e.g.:

{d0|[d1=a ; $x=d2] AND NOT [d1=b AND d2>$x]}

Because of the binding variable, it is no longer possible to use a set-minus approach for implementing NOT. Applicants therefore translate this in the following manner:

SELECT DISTINCT D0 FROM (SELECT V01.D0 D0 FROM V012 VA WHERE VA.D1=A AND NOT V012.D0 IN (SELECT VB.D0 D0 FROM V012 VB WHERE VA.D0=VB.D0 AND VB.D1=B AND VB.D2>VA.D2));

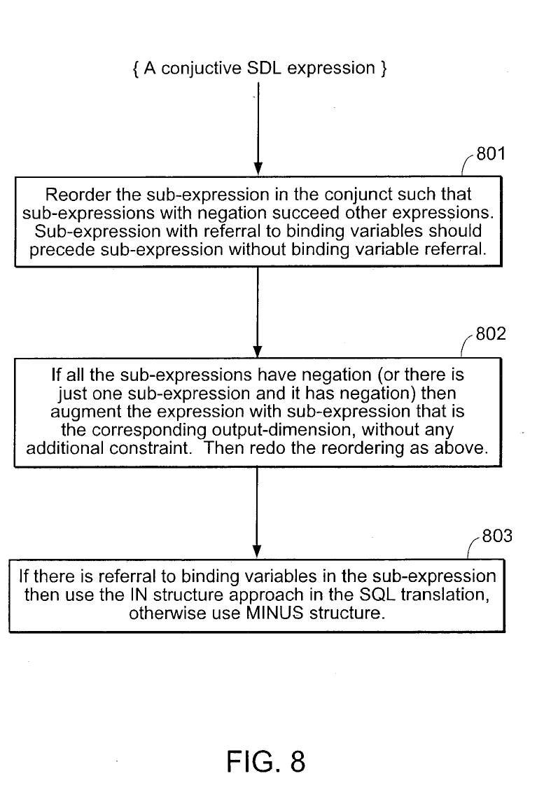

Note that this approach could also have been used for implementing NOT where there are no binding variables, however, it is usually slower than the minus approach. Also notice the renaming of the relations because of the multiple referrals to the same relation. Finally, notice the constraint vA.d0=vB.d0 which is important when nested SQL is used with negation. FIG. 8 summarizes the process for translating a conjunctive SDL expression with negation to SQL.

The process step 801 receives on input a conjunctive SDL expression. In response to the input, the process reorders the sub-expressions in the subject conjunct such that sub-expressions with negations succeed other expressions. The process also provides that sub-expressions with references to binding variables precede sub-expressions without binding variable references.

In step 802, if all the sub-expressions have negation or there is just one sub-expression and it has negation, then the process augments the expression with a sub-expression that is the corresponding output dimension, without any additional constraint. Next step 802 redoes the reordering of step 801.

In step 803, if there is a reference to binding variables in the sub-expression, then the process uses the IN structure approach in the SQL translation. Otherwise, the process uses the MINUS structure.

Nested sets

The invention SDL syntax allows for nested sets through the use of the IN keyword in expressions. Consider the following simple case:

{d0|d1>3 AND d2 IN {d3|d4=3}}

Notice that for this definition to be valid the two dimensions, d2 and d3, have to be from the same domain. The most obvious approach is to translate this in the following manner:

SELECT DISTINCT D0 FROM (SELECT V01.D0 D0 FROM V01, V02 WHERE V01.D0=V02.D0 AND V01.D1>3 AND V02.D2 IN (SELECT V34.D3 D3 FROM V34 WHERE V34.D3=V02.D2 AND V34.D4=3));

Notice the constraint v34.D3=v02.D2 which is instrumental for this to perform well.

Alternatively, this can be written by using a join approach:

SELECT DISTINCT D0 FROM (SELECT V01.D0 D0 FROM V01, V02, V34 WHERE V01.D0=V02.D0 AND V01.D1>3 AND V02.D2=V34.D3 AND V34.D43);

This implementation should be in a form that is easier for the SQL optimizer, with regard to choosing a right execution plan. As seen later, one may rewrite any SDL expression in such a manner that one can apply this join approach instead of the above approach.

Before leaving the IN statements, it is illustrative to see how binding variables can be used inside nested SDL sets:

{d0|[d1>3; $x=d1] AND d2 IN {d3|d4>$x}

is translated as:

SELECT DISTINCT D0 FROM (SELECT V01.D0 D0 FROM V01, V02, V34 WHERE V01.D0=V02.D0 AND V01.D1>3 AND V02.D2=V34.D3 AND V34.D4=V01.D1);

Finally consider:

{d0|[d1>3 AND d2 IN {d3|d4>$x}; $x=d1]}

which is translated as:

SELECT DISTINCT D0 FROM (SELECT V012.D0 D0 FROM V012, V34 WHERE V012.D1>3 AND V012.D2=V34.D3 AND V34.D4=V012.D1);

To conclude the discussion on nested SDL sets and the use of IN in SDL expressions, consider the case where nesting is used inside a nested set:

{d0|d1>3 AND d2 IN {d3|d4>4 AND d5 IN {d6|d7>5}}}

The easiest and most straight forward approach would be to use SQL structure with IN to translate this and use multiple nesting in SQL as well. However, this SDL expression can also be solved with the join approach if the IN term is treated in a similar way as AND is treated:

SELECT DISTINCT D0 FROM (SELECT V01.D0 D0 FROM V01, V02, V34, V35, V67 WHERE V01.D0=V02.D0 AND V01.D1>3 AND V02.D2=V34.D3 AND V34.D4>4 AND V34.D3=V35.D3 AND V35.D5=V67.D6 AND V67.D7>5);

One way to understand the SQL translation better is the following SDL equality:

{d0|d1 AND d2}={d0|[d1 AND d0 IN {d0|d2}]}

General SDL expression

Based on the short expressions above one may deduce a general approach for translating an SDL statement of the invention into an SQL statement. Consider now a general disjunctive expression:

{d0 d1=pi OR (d2=4 AND NOT d3=5)}={d0|SDLexpr1 OR (SDLexpr2)}

The invention system translates this in the manner it translates the simple OR expression, e.g. by using the union approach. By using SDL2SQL to denote a function that translates SDL expressions to corresponding SQL statements, one obtains:

SELECT DISTINCT D0 FROM (SDL2SQL(SDLEXPR1) UNION ALL SDL2SQL(SDLEXPR2))=SELECT DISTINCT D0 FROM SELECT V01.D0 D0 FROM V01 WHERE V01.D1=PI UNION ALL (SELECT V02.D0 D0 FROM V02 WHERE V02.D2=4 MINUS SELECT V03.D0 D0 FROM V03 WHERE V03.D3=5));

Notice how the brackets enclosing the SQL code for SDLexpr2 are necessary because the precedence on UNION and MINUS in SQL is not the same as on NOT and OR in SDL.

Now consider a general conjunctive SDL expression:

{d0|d1=pi AND (d2=4 OR d3=5)}=d0|SDLexpr1 AND (SDLexpr2)

Initially the invention system might translate this in the same manner as it did with the simple AND expression above:

SELECT DISTINCT D0 FROM (SELECT VA.D0 D0 FROM V01 VA, SDL2SQL(SDLEXPR2)) VB WHERE VA.D0=VB.D0 AND VA.D=PI);

To clarify this, expand the SQL statement:

SELECT DISTINCT D0 FROM (SELECT VA.D0 D0 FROM V01 VA, (SELECT V02.D0 D0 FROM V02 WHERE V02.D2=4 UNION ALL (SELECT V03.D0 D0 FROM V03 WHERE V03.D3=5)) VB WHERE VA.D0=VB.D0 AND VA.D1=PI);

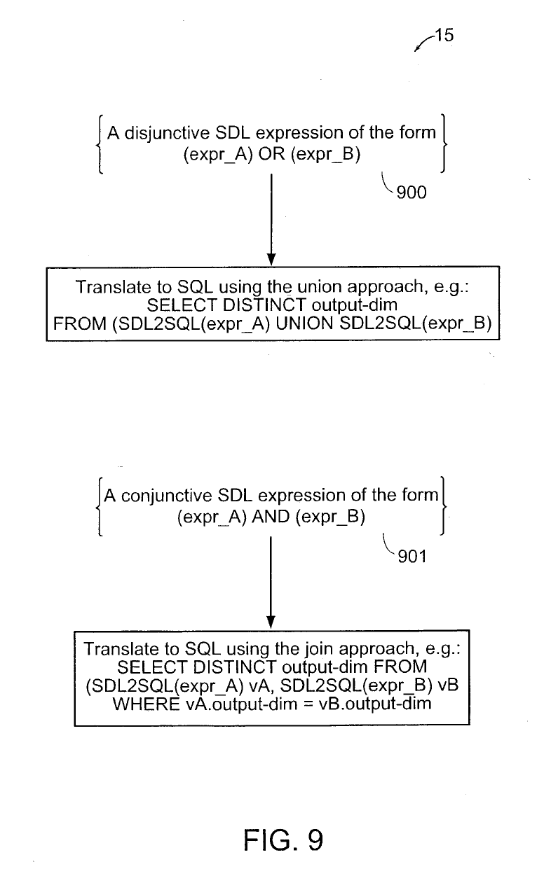

This approach works even when SDLexpr2 contains binding variables defined in SDLexpr1 although the two expressions cannot then be translated separately. FIG. 9 summarizes the general approach for translating disjunctive 900 and conjunctive 901 SDL expressions.

An alternative approach is to use nested SQL with IN statement, the same way as the invention handles negation. The IN-translation approach is considered in the following example where binding variables are also used:

{d0|[d1=pi; $x=d2] AND ([d3=5 AND d2>$x] OR d3=6)}=d0|[d1=pi; $x=d2] AND (SDLexpr2)}

With the IN-translation approach this becomes:

SELECT DISTINCT D0 FROM (SELECT VA.D0 D0 FROM V012 WHERE VA.D1=PI AND VA.D0 IN (SELECT V023.D0 D0 FROM V023 WHERE V023.D0=V12.D0 AND V023.D3=5 AND V023.D2>V012.D2 UNION ALL (SELECT V03.D0 D0 FROM V03 WHERE V03.D0 V012.D0 AND V03.D3=6)))

The drawback with both of these approaches becomes clear if one considers an extreme case where d3=6 is highly selective, much more so than d1=pi. Because of the union operator and the binding variable, the cursors on v023 and v03 will be nested under the cursor on v012. Therefore, for each value of the v012 cursor, a lookup will be done on both v023 and v03. This lookup is approximately twice as more expensive than a lookup only on v023. This example is further discussed later in the description of the OR-distribution rewrite approach.

Query rewrite approaches

In the previous section, Applicants showed how one can map most of the basic structures in the invention SDL syntax to corresponding SQL statements. On purpose, the discussion omitted the handling of brackets since brackets are indeed only to control the evaluation order. In this section, Applicants show rewrite rules of parser 11 (FIG. 2), that amongst other tasks, eliminate all brackets and put a subject SDL statement into conjunctive normal form (CNF) that is easily translated into an efficient corresponding SQL statement.

The rewrite rules of the invention are based on the following rules of algebraic logic:

I. (e)=e

II. e1 AND e2=e2 AND e1

III. (e1 AND e2) AND e3=e1 AND (e2 AND e3)

IV. e1 OR e2=e2 OR e1

V. (e1 OR e2) OR e3 e1 OR (e2 OR e3)

VI. (e1 OR e2) AND e3=(e1 AND e3) OR (e2 AND e3)

VII. (e1 AND e2) OR e3=(e1 OR e3) AND (e2 OR e3)

VIII. NOT(e1) OR NOT(e2)=NOT(e1 AND e2)

IX. NOT(e1 OR e2)=NOT(e1) AND NOT(e2)

X. NOT NOT e=NOT(NOT e)=e

Rules II and IV are based on the commutative law, rules III and V on the associative law and rule VI on the distributive law. Rule VII is not applied by the present invention, however, it is listed for the sake of completeness. Rules VII and VIII are based on deMorgans's law. In particular, Applicants refer to rule VI as OR-distribution.

OR-distribution

Consider the general SDL expression that is made up from three conjuncts:

{d0|SDLexpr1 AND (SDLexpr2 OR SDLexpr3)}={d0 (SDLexpr1 AND SDLexpr2) OR (SDLexpr1 AND SDLexpr3)}={d0 SDLexpr1 AND SDLexpr2 OR SDLexpr1 AND SDLexpr3}

Here the invention drops the brackets and insists that AND has higher precedence than OR in SDL as is the case in most computer languages. As an example consider:

{d0|d1>pi AND ([d2=4 AND d3>0] OR d4=4)}={d0|d1>pi AND [d2=4 AND d3>0] OR d1>pi AND d4=4}

According to the previous sections, using joins for AND and unions for OR, this example is translated into the following SQL statement:

SELECT DISTINCT D0 (SELECT V01.D0 D0 FROM V01, V023 WHERE V01.D0=V023.D0 AND V01.D1>PI AND V023.D2=4 AND V023.D3>0 UNION ALL (SELECT V01.D0 D0 FROM V01, V04 WHERE V01.D0=V04.D0 AND V01.D1>PI AND V04.D4=4));

Continuous application of the OR-distribution results in an SDL expression in a conjunctive normal form (CNF). As an example, consider:

{d0|d1 AND (d2 OR d3 AND (d4 OR d5))}={d0 d1 AND (d2 OR (d3 AND d4) OR (d3 AND d5))}={d0 d1 AND d2 OR d1 AND d3 AND d4 OR d1 AND d3 AND d5}

This is now easily translated to a joins for the conjuncts and unions for the disjuncts. Consider the example from before:

{d0 [d1=pi; $x=d2] AND ([d3=5 AND d2>$x] OR d3=6) }={d0|([d1=pi; $x=d2] AND [d3=5 AND d2>$x]) OR ([d1=pi] AND d3=6)}

Based on the invention's standard translation approaches for AND and OR, one writes this as:

SELECT DISTINCT D0 FROM (SELECT V012.D0 D0 FROM V012, V023 WHERE V012.D1=PI AND V012.D0=V023.D0 AND V023.D2>V012.D2 UNION ALL (SELECT V01.D0 D0 FROM V01, V03 WHERE V01.D0=V03.D0 AND V01.D1=PI AND V03.D3=6));

Written in this way, an SQL optimizer 13 can easily choose an independent execution path for each of the two SQL parts, separated by the union operation, thus resulting in almost twice as low execution cost if d3=6 is highly selective as compared to the other criteria. The difference can be even more dramatic in scenarios where for instance d3=5 is also much more selective than d1=pi, because with this SQL structure, the SQL optimizer 13 can choose to make the cursor on v01 to be the most nested in both parts of the SQL statement, whereas, most SQL optimizers will not do that in the two previous SQL statements (see R. Ramakrishnan and J. Gehrke, “Database Management Systems”, 2nd ed., McGraw Hill, (2000)).

Finally, it is interesting to see how OR-distribution can help in expressions with negation:

{d0|d1=1 AND (NOT d2=2 OR d3=3)}

By using the IN-translation approach this would map to:

SELECT DISTINCT D0 (SELECT V01.D0 D0 FROM V01 WHERE V01.D1 =1 AND V01.D0 IN (SELECT V0.D0 D0 FROM V0 WHERE V0.D0 NULL MINUS SELECT V02.D0 D0 FROM V02 WHERE V02.D2=2 UNION ALL (SELECT V03.D0 D0 FROM V03 WHERE V03.D3=3)));

The problem with this statement is that the part: “SELECT V0. D0 D0 FROM V0 WHERE V0. D0 !=NULL” can be quite costly since v0 can be quite large (see the discussion on inclusion criteria for dimension). By using OR-distribution the SDL expression becomes:

{d0|d1=1 AND NOT d2=2 OR d1=1 AND d3=3}

and the corresponding SQL translation results:

SELECT DISTINCT D0 (SELECT V01.D0 D0 FROM V01 WHERE V01.D1 =1 MINUS SELECT V02.D0 D0 FROM V02 WHERE V02.D2=2 UNION ALL (SELECT V01.D0 D0 FROM V01, V03 WHERE V01.D0=V03.D0 AND V01.D1=1 AND V03.D3=3));

OR-distribution in record-operators

The use of OR inside a record-operator can be a shorthand for defining two separate record-expressions or a way for setting two different conditions on the same dimension. In order to understand this consider the following cases:

{d0|[d1=4 AND (d2>2 OR d3<−2)]}={d0[d1=4 AND d2>2] OR [d1=4 AND d3<−2)]}

In this case Applicants apply the OR-separation and translate it to SQL in the following way:

SELECT DISTINCT D0 FROM (SDL2SQL({d0|[d1=4 AND d2>2]})

UNION ALL (SDL2SQL({d0|[d1=4 AND d3>2]})));

Each of the SDL2SQL blocks is translated to an efficient join. In the next example the situation is different:

{d0|[d1=4 AND (d2>2 OR d2<−2)]}={d0|[d1=4 AND d2>2] OR [d1=4 AND d2<−2)]}

In this example one could use the rewrite as shown, however, this will result in a UNION ALL operation in the SQL statement. If the SQL optimizer 13 chooses to use d1 as the outer-relation in the joins, the cost of evaluating this using this approach is two times higher than if the statement is translated directly to SQL, without the rewrite:

SELECT DISTINCT D0 FROM (SELECT V01.D0 D0 FROM V012 WHERE V012.D1=4 AND (V012.D2>2 OR V012.D2<−2));

If the SQL optimizer 13 chooses d2 as the outer-relation, there is however no difference, since index-lookup on a condition with OR is implemented using UNION, unless the database uses a full-scan on the table. The present invention however does not apply the rewrite since the SQL optimizer 13 can then choose to do so based on its cost estimates. Now, consider the following case:

{d0|=[d1=4 AND (d2>2 OR d2−d1<−2)]}={d0[d1=4 AND d2>2] OR [d1=4 AND d2−d1<−2)]}

Here the present invention does not apply this rewrite since both of the record-expressions contain the same set of dimensions.

On the other hand consider:

{d0|[d1=4 AND (d2>2 OR d2−d3<−2)]}={d0|[d1=4 AND d2>2] OR [d1=4 AND d2−d3<−2)]}

Here the two record-expressions that result after the rewrite have different sets of dimensions, hence, it is necessary to apply the rewrite because the following straight forward mapping based on the first SDL form would be incorrect:

SELECT DISTINCT D0 FROM (SELECT V0123.D0 D0 FROM V0123 WHERE V0123.D1=4 AND (V0123.D2>2 OR V0123.D2−V0123.D3 <−2);

The reason why this is incorrect is that the view v023 assumes the existence of d3 even though d3 is not required. Translation of the rewritten SDL expression gives on the other hand:

SELECT DISTINCT D0 FROM (SELECT V012.D0 D0 FROM V012 WHERE V012.D1=4 AND V012.D2>2 UNION ALL (SELECT V0123.D0 D0 FROM V0123 WHERE V0123.D1=4 AND V0123.D2−V0123.D3<−2));

To summarize, the invention applies the OR-distribution on record-expressions if it results in record-expressions with different sets of dimensions, i.e. if the conjuncts inside a subject record-expression have different sets of dimensions, the record-expression is separated into multiple record-expressions.

OR-distribution and nested sets

Consider now an SDL expression with an IN statement and a disjunctive expression in a nested set:

{d0|d1 IN {d2|d3=3 OR d3=4}}

This can be translated in the following manner:

SELECT DISTINCT D0 FROM (SELECT V01.D0 D0 FROM V01, V23 WHERE V01.D1=V23.D2 AND (V23.D3=3 OR V23.D3=4);

If one changes this slightly by replacing the latter d3 by d4, one will have to apply the following rewrite in order to be able to use the same SQL structure:

{d0|d1 IN {d2|d3=3 OR d4=4}}={d0|d1 IN {d2|d3=3} OR d1 IN {d2|d4=4}}

This can be translated in the following manner:

SELECT DISTINCT D0 FROM (SELECT V01.D0 D0 FROM V01, V23 WHERE

V01.D1=V23.D2 AND V23.D3=3

UNION ALL (SELECT V01.D0 D0 FROM V01, V24 WHERE V01.D1=V23.D2 AND V24.D3=4));

Hence, this shows that one can treat IN statements in the same way as record-expressions, i.e. one can apply OR-distribution within the nested SDL sets. Without this approach the expression shown above would have to be mapped using nested-SQL or the following:

SELECT DISTINCT D0 FROM (SELECT V01.D0 D0 FROM V01 WHERE V01.D1 IN (SELECT V23.D2 D2 FROM V23 WHERE V01.D1=V23.D2 AND V23.D3=3

UNION ALL (SELECT V24.D2 D2 FROM V24 WHERE V01.D1=V24.D2 AND V24.D4=4))

or alternatively as:

SELECT DISTINCT D0 FROM (SELECT V01.D0 D0 FROM V01,(SELECT V23.D2 D2 FROM V23 WHERE V23.D3=3 UNION ALL (SELECT V24.D2 D2 FROM V24 WHERE V24.D4=4)) V2 WHERE V01.D1=V2.D2);

As mentioned before, the drawback with these two approaches is that the SQL-optimizer 13 will not be able to handle this structure as well as the alternative proposed above.

OR-merging

Consider now a general structure of a CNF formatted SDL expression:

{d0|ANDexpr1 OR ANDexpr2 OR SDLexpr3}

If any two conjuncts have the same set of dimensions, they can be merged together in the translation to SQL. A simple example explains this:

{d0|d1=1 AND d2=2 OR d1=3 AND d2=4}

which can be translated in the following manner:

SELECT DISTINCT D0 FROM (SELECT V012.D0 D0 FROM V012 WHERE (V012.D1=1 AND V012.D2=2) OR (V012.D1=3 AND V012.D2=4));

This can give a factor of two in speed increase in cases where the SQL optimizer chooses full scan. Note however that the merge cannot be applied for conjuncts that differ by a NOT connective or by reference to different binding variables.

Negations

Query rewrites related to negation can be done according to rules VIII-X as well as rule II above. As an example consider the following SDL expression:

{d0|NOT d1=1 AND d2=2}={d0|d2=2 AND NOT d1=1}

In the initial form the SDL expression is not easily translated to SQL using a left-to-right join approach, however, after the rewrite based on the commutative law, it is easily translated to:

SELECT DISTINCT D0 FROM (SELECT V02.D0 D0 FROM V02 WHERE V02.D2=2 MINUS SELECT V01.D0 D0 FROM V01 WHERE V01.D1=1);

or to a corresponding SQL with IN keyword:

SELECT DISTINCT D0 FROM (SELECT V02.D0 D0 FROM V02 WHERE V02.D2=2 AND V02.D0 NOT IN (SELECT V01.D0 D0 FROM V01 WHERE V01.D0=V02.D0 AND V01.D1=1));

The latter structure works also when the second part of the conjunction contains a reference to a binding variable defined in the other half, as mentioned earlier. The present invention therefore pushes negations to the end of any conjunct. For instance if there is more than one negation:

{d0|d1=1 AND NOT d2=2 AND NOT d3=3}

This can be translated as:

SELECT DISTINCT D0 FROM (SELECT V01.D0 D0 FROM V01 WHERE V01.D1=1

AND V01.D0 NOT IN (SELECT V02.D0 D0 FROM V02 WHERE V01.D0=V02.D0 AND V02.D2=2)

AND V01.D0 NOT IN (SELECT V03.D0 D0 FROM V03 WHERE V01.D0=V02.D0 AND V03.D3=3));

or into an SQL form using two MINUS operations.

If negation is in front of two or more disjunctive SDL expressions, the invention applies rewrite according to rule VIII, e.g.:

{d0|NOT(e1) OR NOT(e2) OR e3}={d0|NOT(e1 AND e2) OR e3}

In this example, one saves one set-subtraction from the “universe” as explained in previous sections. If negation encloses brackets, the present invention only applies rewrite if it contains a conjunctive expression according to rule IX. Before concluding discussion on rewrite approaches for negation, Applicants take one detailed example:

{d0|[d1;$x=d1] AND NOT(d2>$x OR d3 OR NOT(d4))}={d0|[d1;$x=d1] AND NOT(d2>$x) AND NOT(d3) AND d4}={d0|d4 AND [d1;$x=d1] AND NOT(d2>$x) AND NOT(d3)}

Notice how the negation with the referral to the binding variable precedes the other negation because it has to be implemented with an IN structure whereas the latter term can be enforced by subtraction using MINUS:

SELECT DISTINCT D0 FROM (SELECT V04.D0 D0 FROM V04, V01 WHERE V04.D0 !=NULL AND V01.D0 !=NULL AND V04.D0=V01.D0 AND V01.D0 NOT IN (SELECT V02.D0 FROM V02 D0 WHERE V01.D0=V02.D0 AND V02.D2>V01.D1)

MINUS SELECT V03.D0 D0 FROM V03 WHERE V03.D0 !=NULL);

Undefined binding variables

The rewrite approaches suggested above, i.e. to translate the SDL expression into CNF, have an interesting side effect when it comes to the binding variables. Here Applicants explain how the invention treats binding variables that appear in a different conjunct than where they are declared. Consider for instance the following example:

{d0|([d1;$x=d3] OR [d2;$y=d3]) AND ([d4 AND d3>$x] OR [d4 AND d3>$y])}

If one rewrites this SDL expression after performing OR-distribution, one obtains:

{d0|([d1;$x=d3] AND [d4 AND d3>$x]) OR ([d1;$x=d3] AND [d4 AND d3>$y]) OR ([d2;$y=d3]) AND [d4 AND d3>$y]) OR ([d2;$y=d3] AND [d4 AND d3>$x])}

Notice that the SDL expression now consists of four conjuncts and that in the second and the fourth conjuncts, there are binding variables that are not defined within the same conjunct. One might think that the invention approach for implementing binding variables no longer holds, i.e. with join operation, since the scope of variables does not extend over the UNION statement in SQL that is used for implementing OR. Applicants recognize, however, that conjuncts with undefined binding variables are FALSE, that is they can be eliminated from the disjunctive expression. The results therefore are:

{d0|[d1;$x=d3] AND [d4 AND d3>$x] OR [d2;$y=d3] AND [d4 AND d3>$y]}

Applicants also recognize that this expression could have been rewritten in another way:

{d0|[d1 OR d2;$x=d3] AND [d4 AND d3>$x]}

This is because the SDL syntax allows disjuncts that arise because of different dimensions inside the SDL record operator. Consider another example:

{d0|([d1;$x=d2] OR d3) AND ([d4>$x] OR d5)}

This is a perfectly legal SDL expression, assuming that the dimensions d2 and d4 are of the same domain. Without rewrite approaches, it is non-trivial to transform this to SQL since the relation (d0,d1,d2) is different from (d0,d3). One might try the following SQL code:

SELECT DISTINCT D0 FROM (SELECT VA.D0 D0 FROM (SELECT V012.D0 D0 FROM V012 WHERE V012.D0 NULL UNION ALL (SELECT V03.D0 D0 FROM V03 WHERE V03.D0 NULL)) VA, (SELECT V04.D0 D0 FROM V04 WHERE V04.D4>V012.D2 UNION ALL (SELECT V05.D0 D0 FROM V05 WHERE V05.D0 !=NULL)) VB WHERE VA.D0=VB.D0));

Notice however, that referral to V012.D2 (boldface in the SQL statement) is illegal since it is not within scope there. Also notice that it would be impossible to refer to it as VA.D2 because the relation V03 does not have the D2 dimension and therefore, the relation VA only contains the D0 dimension. The reader can verify the other approach that was described above for translating a general SDL expression to SQL, i.e. using the IN keyword, is also non-trivial in this example. The solution is however to apply OR-distribution to the SDL expression before translation to SQL:

{d0|([d1;$x=d2] OR d3) AND ([d4>$x] OR d5)}={d0|[d1;$x=d2] AND [d4>$x] OR [d1;$x=d2] AND d5 OR d3 AND [d4>$x] OR d3 AND d5}

Applicants recognize one conjunct term in the disjunction with an “undefined” binding variable and eliminate that term as discussed above. Hence one obtains:

{d0|[d1;$x=d2] AND [d4>$x] OR [d1;$x=d2] AND d5 OR d3 AND d5}

This is easily translated to SQL with three joins unioned together.

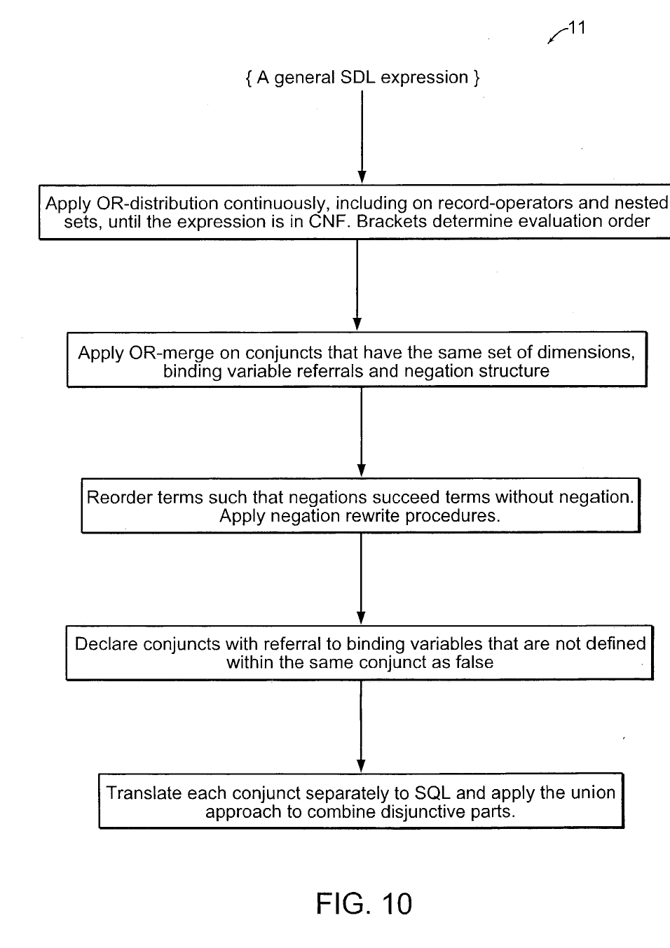

FIG. 10 illustrates the foregoing optimization and translation routines and procedures for optimized translation of SDL to SQL which uses a parser 11 in initial steps. This optimized translation has the benefit of generating SQL that is faster, especially on RDMS where the SQL optimizer is not too good.

View-union rewrite

In the discussion on tables and metadata, Applicants demonstrated how the SDL system uses its metadata to construct virtual relations by combining all the tables that contain the proper dimensions with the union operator. That approach causes the union operator to be applied before the joins are calculated (unless the SQL optimizer does the same rewrite as Applicants are proposing here). Consider the following expression:

{d0|d1 AND d2}

Without the loss of generality, Applicants assume that tables A and B store relations (d0,d1) and that tables C and D store relations (d0,d2). One can indeed introduce a “special” dimension, T, that denotes the table in which the tuples (records) are stored. Then the expression above can be written as:

{d0|[d1 AND (T=A OR T=B)] AND [d2 AND (T=C OR T=D)]}

Notice that this specifies a constraint on the dimension T, a constraint that is equivalent to “no constraint” given the assumptions about the data stored in the system. With the invention's regular SQL translation approach, this would be written as:

SELECT DISTINCT D0 FROM (SELECT V01.D0 D0 FROM V01, V02 WHERE V01.D1 !=NULL AND V02.D2 !=NULL AND V01.D0=V02.D0);=SELECT DISTINCT D0 FROM SELECT V01.D0 D0 FROM (SELECT V01.D0 D0 FROM (SELECT D0, D1 FROM A UNION ALL SELECT D0, D1 FROM B) V01, (SELECT D0, D2 FROM C UNION ALL SELECT D0, D1 FROM D) V02 WHERE V01.D1!=NULL AND V02.D2 !=NULL AND V01.D0=V02.DO);

Now consider if OR-distribution is applied on the special table dimension, T:

{d0|[d1 AND T=A] AND [d2 AND T=C] OR [d1 AND T=A] AND [d2 AND T=D] OR [d1 AND T=B] AND [d2 AND T=C] OR [d1 AND T=B] AND [d2 AND T=D]}

The corresponding SQL code takes the following form:

SELECT DISTINCT D0 FROM (SELECT V01.D0 D0 FROM (SELECT V01.D0 D0 FROM A) V01, (SELECT D0, D1 FROM C) V02 WHERE V01.D1 !=NULL AND V02.D2 !=NULL AND V01.D0=V02.D0) UNION ALL

SELECT V01.D0 D0 FROM (SELECT V01.D0 D0 FROM A) V01, (SELECT D0, D1 FROM D) V02 WHERE V01.D1 !=NULL AND V02.D2 !=NULL AND V01.D0=V02.D0) UNION ALL SELECT V01.D0 D0 FROM (SELECT V01.D0 D0 FROM B) V01, (SELECT D0, D1 FROM C) V02 WHERE V01.D1 !=NULL AND V02.D2 NULL AND V01.D0=V02.D0) UNION ALL

SELECT V01.D0 D0 FROM (SELECT V01.D0 D0 FROM B) V01, (SELECT D0, D1 FROM D) V02 WHERE V01.D1 !=NULL AND V02.D2 !=NULL AND V01.D0=V02.D0);

After the rewrite, each conjunct is implemented with a join of only two tables, i.e. the relation view v01 does not have to be implemented with the union operator. Instead, the union is carried out because of the disjunctive nature of the whole expression. The union has therefore been moved further back into the evaluation, i.e. after the join whereas it is before the join in the original implementation. Notice that this allows the optimizer to choose a separate execution plan for each join, hence it is more likely to perform well if the tables have different sizes, cardinality and indices. Finally, it is worth mentioning that view-union rewrite does not require the definition of a special dimension for table names. Those skilled in the art should see that the bookkeeping for this distribution rewrite could be carried out where a conjunct is translated to SQL code.

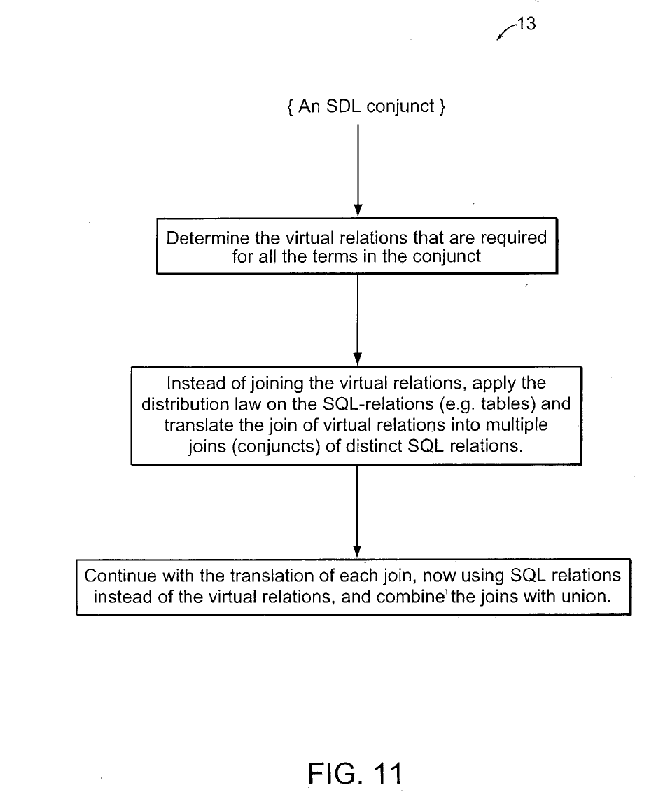

FIG. 11 is a flow diagram of a view-union rewrite optimization procedure (by optimizer 13) according to the foregoing. Other similar procedures are suitable.

Automatic record-operator enforcement

The SDL syntax uses square brackets to denote a record operator. The record-operator is used to enforce more than one criterion on a single relation instance (tuple/record). There are cases where the nature of the data is such that two expressions, with and without a record-operator, are equivalent. This is explored next along with a rewrite optimization strategy that utilizes this fact.

Applicants assume that one has some conjunctive expression:

{d0|d1 AND d2 AND d3 AND d4

One can group all dimensions in a conjunct together into a set, R, where the following holds: each dimension in R takes part in the same relations as any other dimension in R, and for all those relations, the output-dimensions (d0) is declared with its multiplicity as “unique”. As an example, if d1, d3 and d4 only exist in a single relation (d0, d1, d3, d4) where d0 is unique, then the expression above can be rewritten as:

{d0|d2 AND [d1 AND d3 AND d4]}

This will change the SQL translation from a 4-table join into a 2-table join, which can be dramatically much faster. A practical example of this is where one has a singleton relation with information on individuals such as (pid, sex, dob, dod), i.e. demographic information. Consider a typical query:

{pid|dob>1950 AND sex=male AND diag:stroke AND date-dob>30}

This expression could be automatically rewritten to:

{pid|[dob>1950 AND sex=male] AND diag:stroke AND date-dob>30}

Notice that since there can be multiple records in (pid, diag, date) for each patient, diag and date would not automatically be locked into a record. In this case, the user is however, most likely trying to make the following query:

{pid|[dob>1950 AND sex=male; $x=dob] AND (diag:stroke AND date-$x>30]}

Notice that since the dimension for date of birth, dob, is not in the same relation as date, it cannot be placed into the record-operator, except though a binding variable.

As another example take the following query:

{pid|dob>1950 AND sex=male AND dod-dob>90}

Because all of the four dimensions that appear in this conjunct only exist in one and only one relation and where the pid is unique, this could be automatically rewritten as:

pid|[dob>1950 AND sex=male AND dod-dob>90]}

As for the view-union rewrite, automatic record-operator enforcement is easily implemented where a conjunct is translated to SQL. Each SQL cursor that is generated for the conjunct join can be inspected and all cursors that refer to the same table(s) can be merged if the output-dimension in them is declared unique. In other words, this would eliminate unnecessary self-joins.

Pivoted dimensions

Next discussed is an extension to the standard SDL syntax (see the SDL syntax specification below) that allows the SDL language to treat dimensions in a hierarchical manner. This extension requires small changes to the meta-data presented earlier and minor changes to the SDL “calc-expr” definition. As shown below, the benefit of this extension is to allow measurements to be classified in a hierarchical manner without using the record-operator.

The extension redefines the calc-expr such that it includes “dimension:code”. To clarify this, Applicants take an example of an SDL expression that utilizes this extension:

{pid|meas:bloodpressure.high>120}

In this example, all measurements have been combined into what looks like a single dimension. Without this extension, the expression would have to be written as:

{pid meas:bloodpressure.high AND value>120}

The data could also have been formatted such that each type of measurement would reside in a separate dimension, e.g.:

{pid|bloodpressure.high>120}

With the invention extension, multiple dimensions are in effect pivoted into a single column and an additional column is needed to store its value. This can also be referred to as vertical representation. Unless the values are stored as strings and converted to the proper domain data type on the fly, all the dimensions that are pivoted together should be of the same data type. To support this extension, it is necessary to augment the meta-data. One way to do that is to store an additional column in the table domains, SQLpivoted_type, and an additional column in dim2rel, pivoted_value_column.

The SDL system 102 would then recognize dimensions that have non-null values in value_column and treat them appropriately when translating the SDL expression to SQL.

Applicants rewrite the first SDL expression in a more general manner:

{d0|d1:a.b>120}

This expression would be translated to the following SQL code:

SELECT DISTINCT D0 FROM (SELECT V01X.D0 D0 FROM V01X WHERE (V01X.D1 LIKE ‘A.B.%’ OR V01X.D1=‘A.B’) AND V01X.X=120)

Here the column name of the pivoted_value_column is “x” and the virtual view that includes d0, d1 and x is denoted with v01x. It should be noted that although this pivoting extension provides additional flexibility and extends the SDL schema such that it encompasses “all” relational schemas, e.g. horizontal, vertical, and partially pivoted data structure, it is usually more efficient to store dimensions in separate columns.

SDL syntax specification

set-definition:

setname=sdl-set

setname(parameters)=sdl-set

sdl-set:

{dimension|expression}

sdl-set+sdl-set

sdl-set−sdl-set

expression:

code-expression

expression AND expression

expression OR expression

NOT expression

(expression)

[record-expression]

[record-expression; binding-list]

WITHIN(variablelist; constant)

parameterlist:

parameter

parameterlist, parameter

parameter:

calc-expr

binding-list:

variable=dimension

binding-list, variable dimension

variablelist:

variable

variablelist, variable

record-expression:

code-expression

record-expression AND record-expression

record-expression OR record-expression

NOT record-expression

(record-expression)

code-expression:

dimension:code

relational-expression

setname(parameter list)

dimension IN sdl-set

relational-expression:

calc-expr rel-op calc-expr

rel-op: >, <, >=, <=,

calc-expr:

constant (e.g. domain code value)

variable

parameter

dimension

(calc-expr)

-calc-expr

calc-expr calc-op calc-expr

FUNCTION( calc-expr)

aggregate

calc-op: +, −, *, /

aggregate:

id-code-aggregate

set-code-aggregate

id-code-aggregate

aggregate-op [dimension]

aggregate-op [dimension; record-expression]

set-code-aggregate

set-aggregate-op [dimension; model-expression]

set-aggregate-op [dimension; model-expression; record-expression]

aggregate-op:

COUNT, DISTINCT, AVG, STD, VAR, MAX, MIN, MEDIAN, FIRST, LAST

SDL Client Components

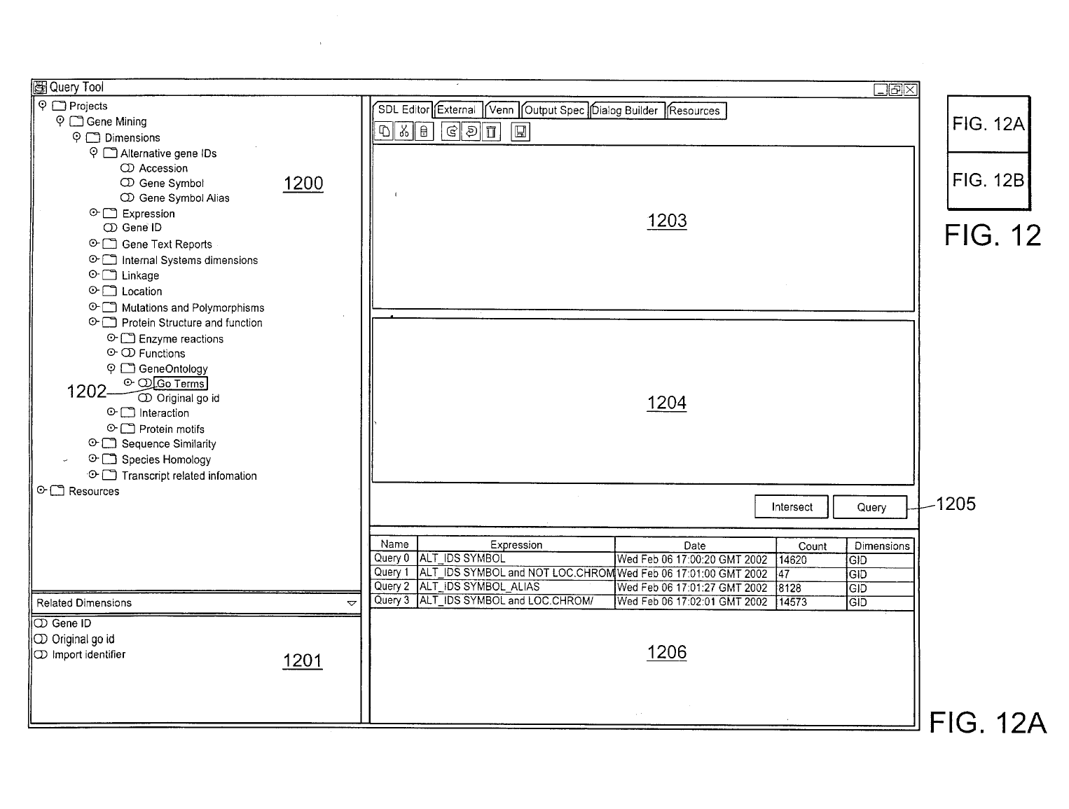

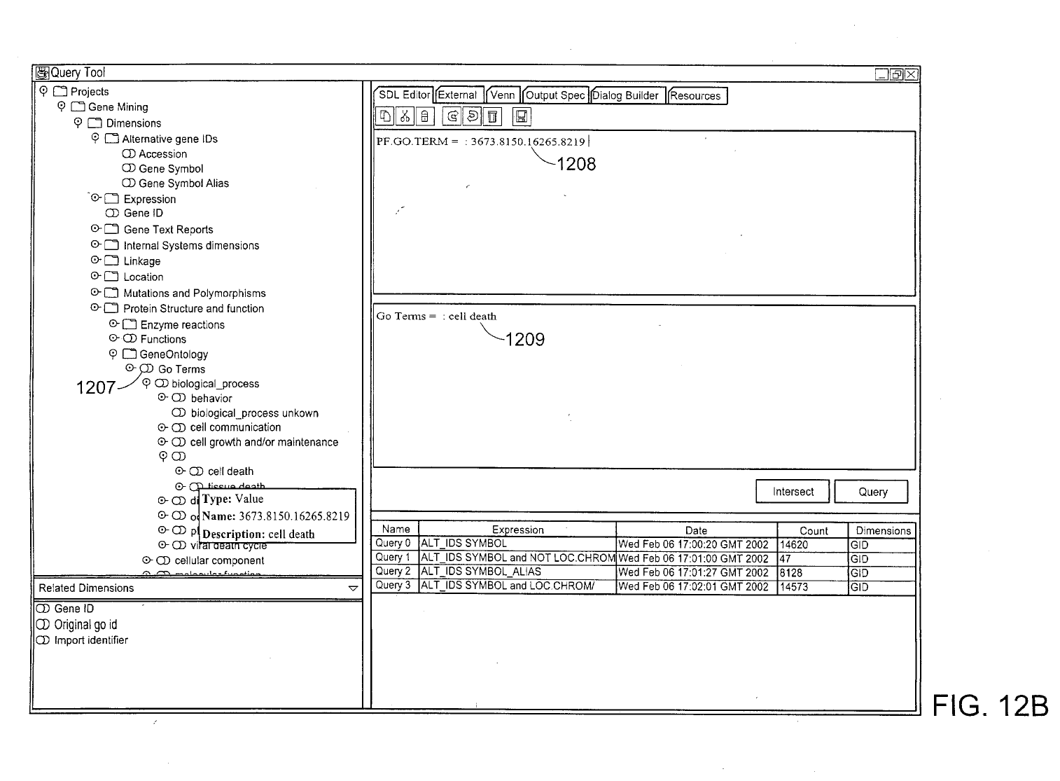

This invention describes several client software-components that can be used to facilitate the creation of SDL queries. FIG. 12 shows a composite query tool comprised of several independent components. According to FIG. 1, the tool in FIG. 12A can be divided into a data-explorer 1200 and 1201 and a query-composer 1203 and 1204. In 1200 one sees a tree-browser that provides an overview of the meta-data in the system. In this example, it shows the dimensions presented in hierarchial manner. It could also present the dimensions beneath the corresponding domains or the SQL relations that they belong to or any other system that may be useful for the user to group and classify the dimensions. The window in 1201 shows the dimensions that are related to the selected dimensions in 1202. This window can also be configured to show all the SQL-relations that the selected dimension exists in. An SDL syntax aware editor is shown on the right side of FIG. 12A. It is split up into the editing part 1203 that shows the dimensions and a description part 1204 that shows the descriptions of the dimensions that are stored in the metadata. Finally, shown are a button 1205 for launching the SDL query and a list box 1206 showing information about the sets that have been generated with SDL queries.

For enumerable dimensions, the data-explorer 1200 has the unique feature of allowing the user to drill into the domain-values that are stored in a corresponding hierarchy, e.g. the gene-ontology classification scheme 1207 (FIG. 12B). This enables the user to drag-and-drop into the editor both the dimension and the corresponding condition on that dimension 1208. The description view 1209 shows the corresponding statement with the description taken from the hierarchy table, e.g. 307 in FIG. 3.

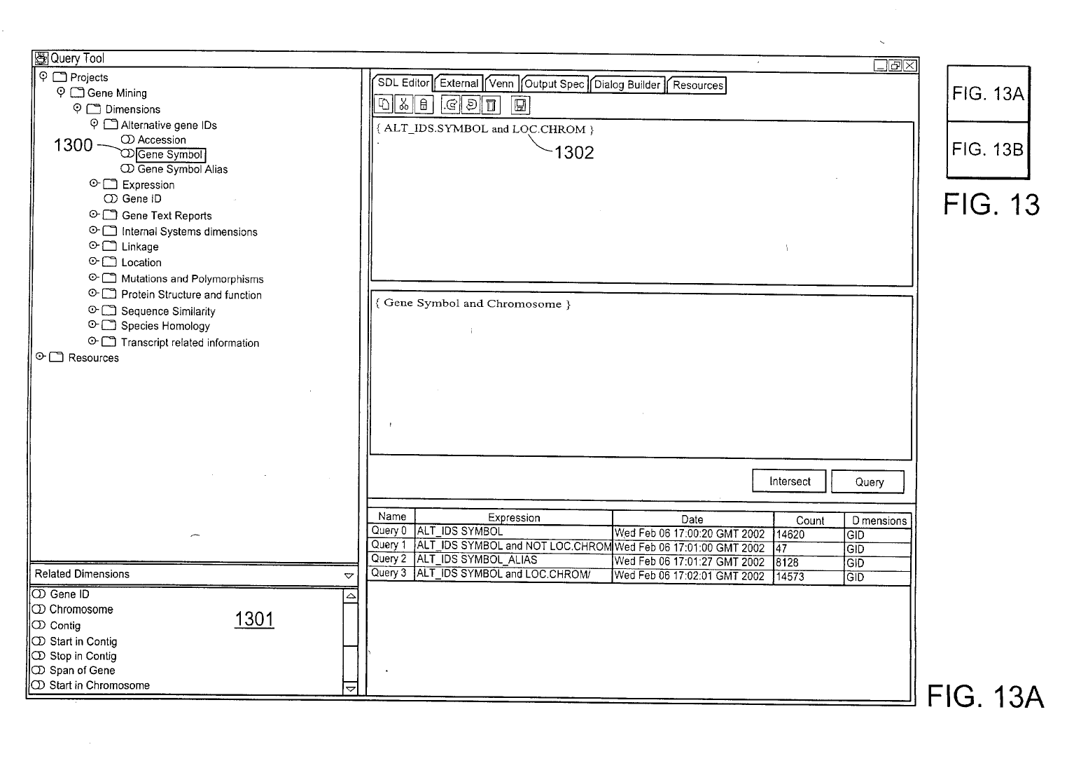

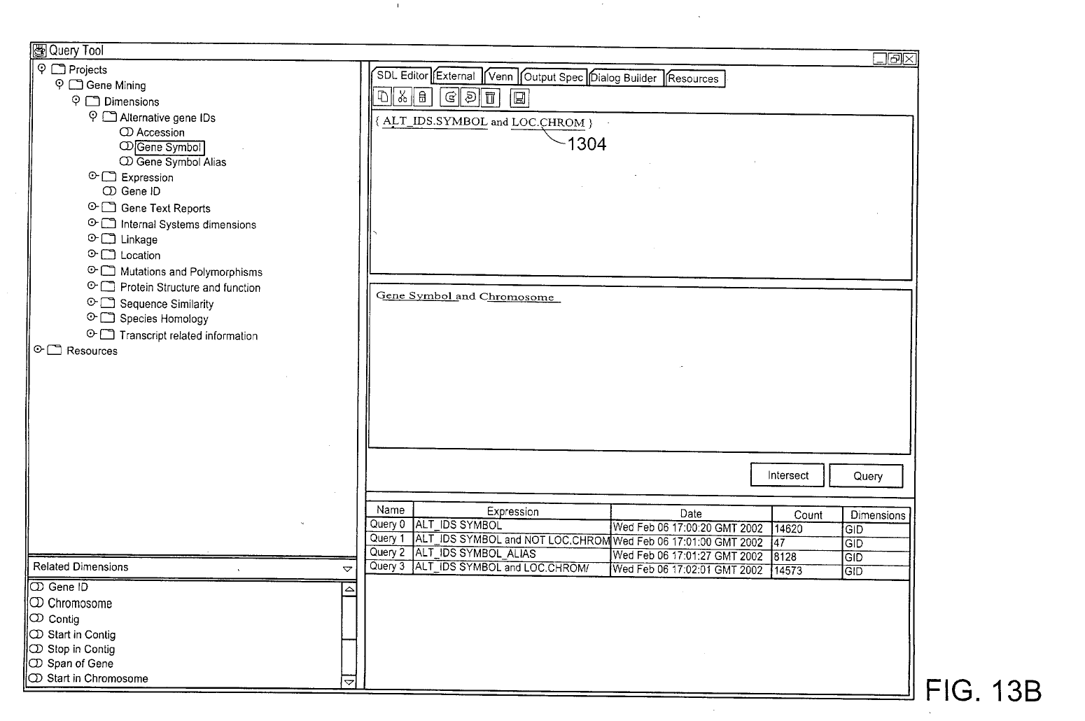

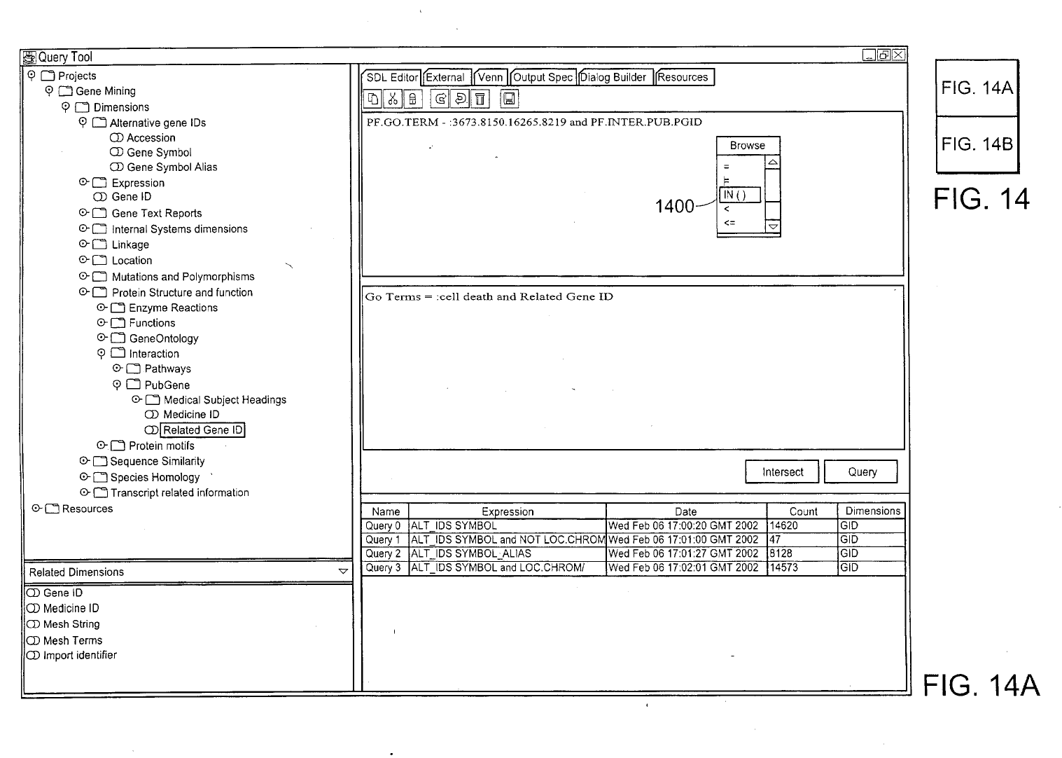

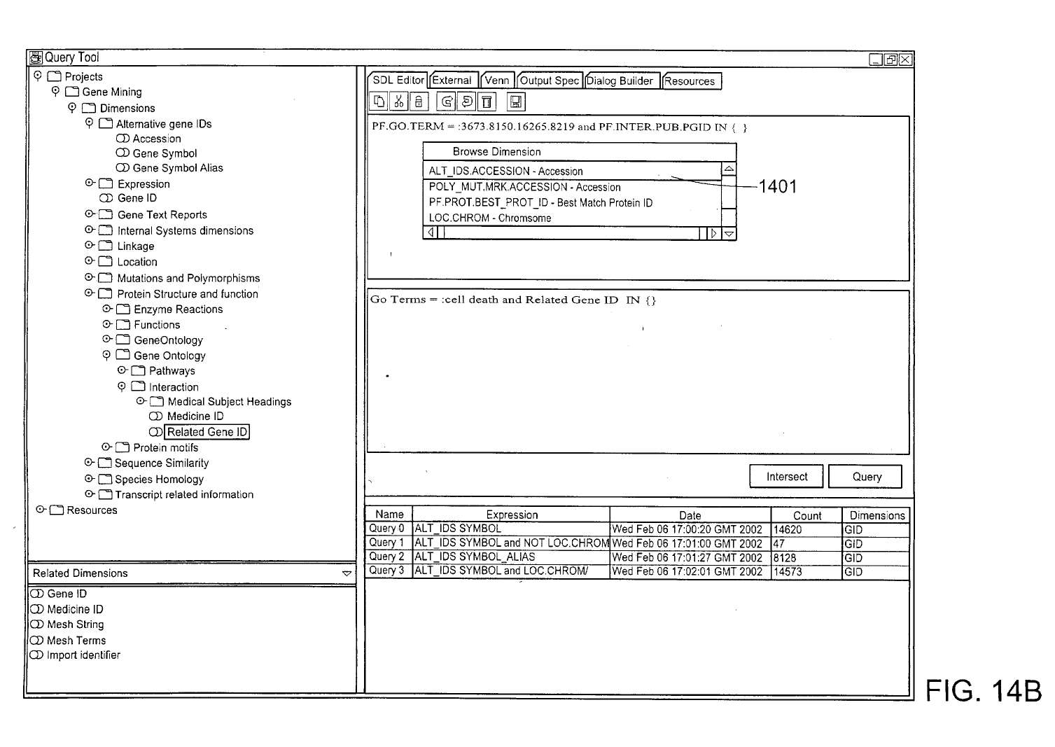

The SDL users are not required to think about the tables that store the data. However, they need to understand when they can apply the record-operator on relations. FIG. 13 shows how the composite tool supports that. For the selected dimension, 1300 (FIG. 13A), the view 1301 shows that chromosome exist in a relation with gene-symbol. Hence, the user can apply the record-operator as shown in 1302. The editor also warns the user if he does not enclose dimensions that exist in a relation into a record operator 1304 (FIG. 13B), e.g. with underline marks. This does however, not necessarily have to be an error (see the discussion of automatic enforcement of record-operator). As shown in FIG. 14, the editor also has syntax-aware support for the insertion of SDL keywords 1400 (FIG. 14A) and dimension and domain values insertions 1401 (FIG. 14B).

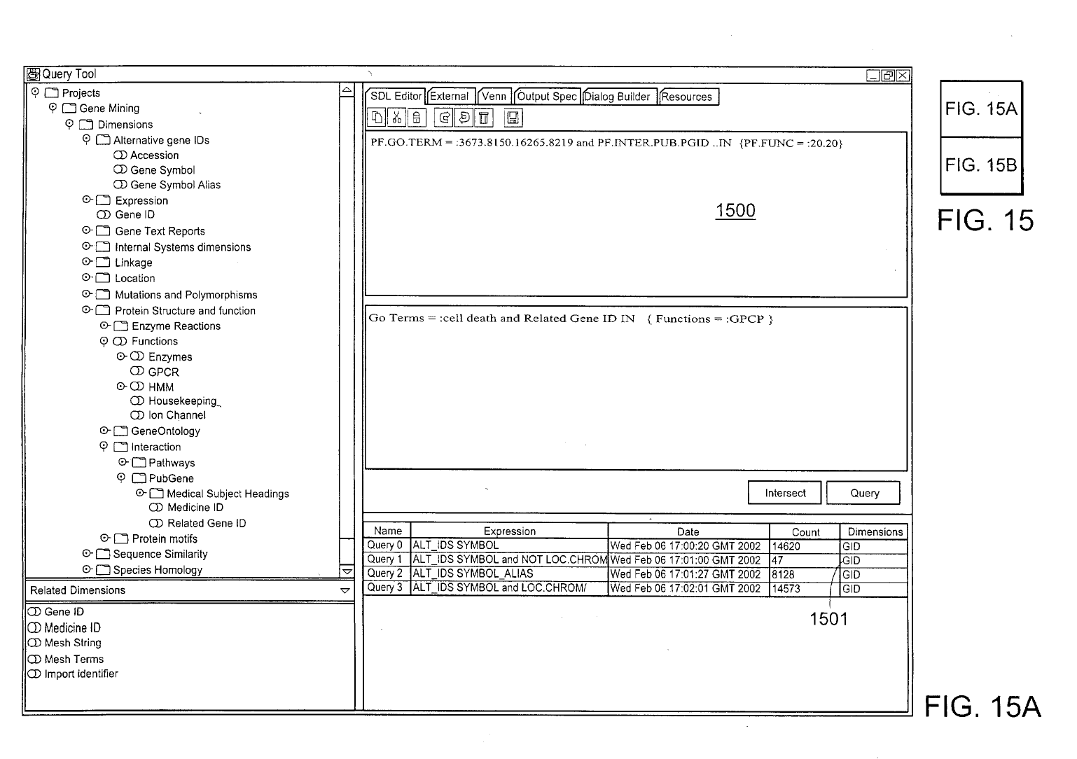

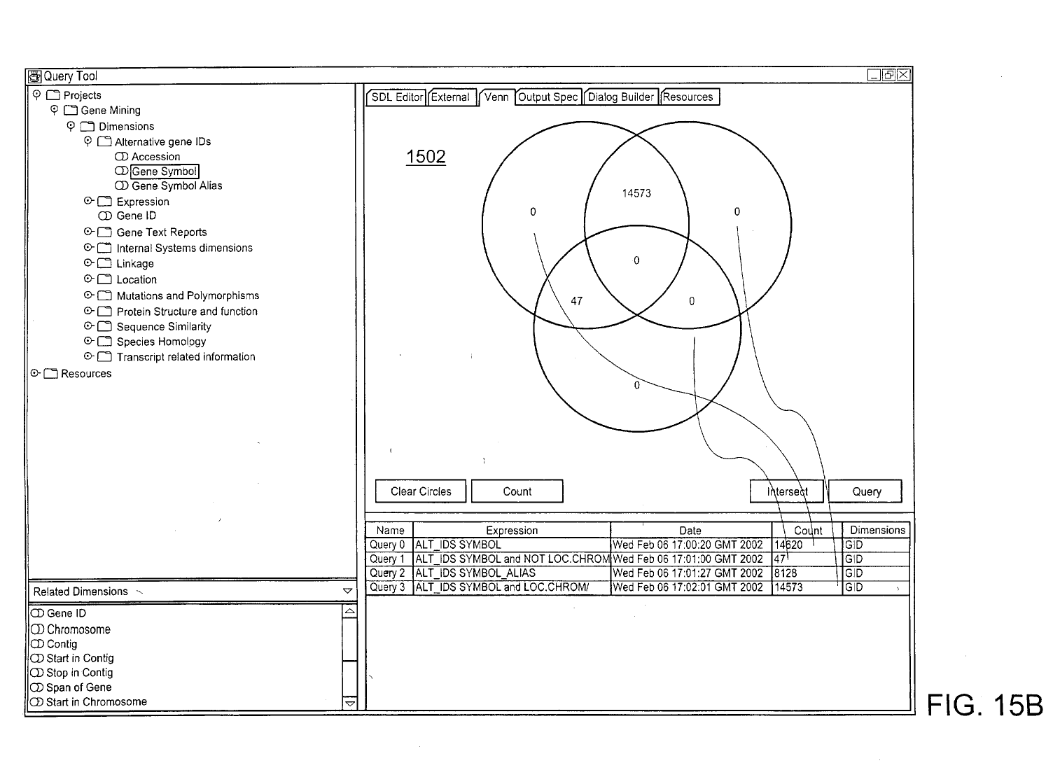

FIG. 15 shows how the editor 1203, 1204 can be configured such that the user does not have to specify either the output-dimensions or the curly-brackets of the set. The expression in 1500 (FIG. 15A) is an example of this and notice that the output-dimension in the nested set can also be omitted if it is the same as the default out-put dimension. In this example the default output-dimension is GID as shown in 1501 (FIG. 15A). The composite query tool provides a Venn-tool 1502 (FIG. 15B) that allows sets of the same type to be analyzed. In one embodiment, the Venn-tool is generally an automatic SDL query generator.

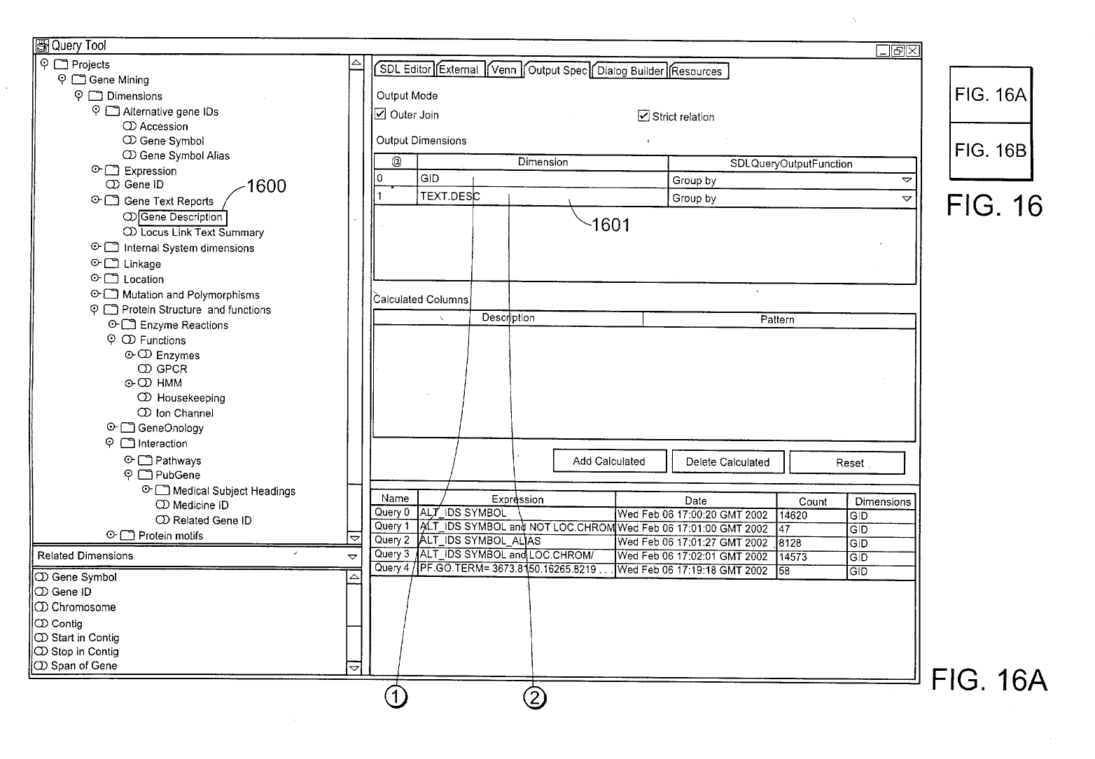

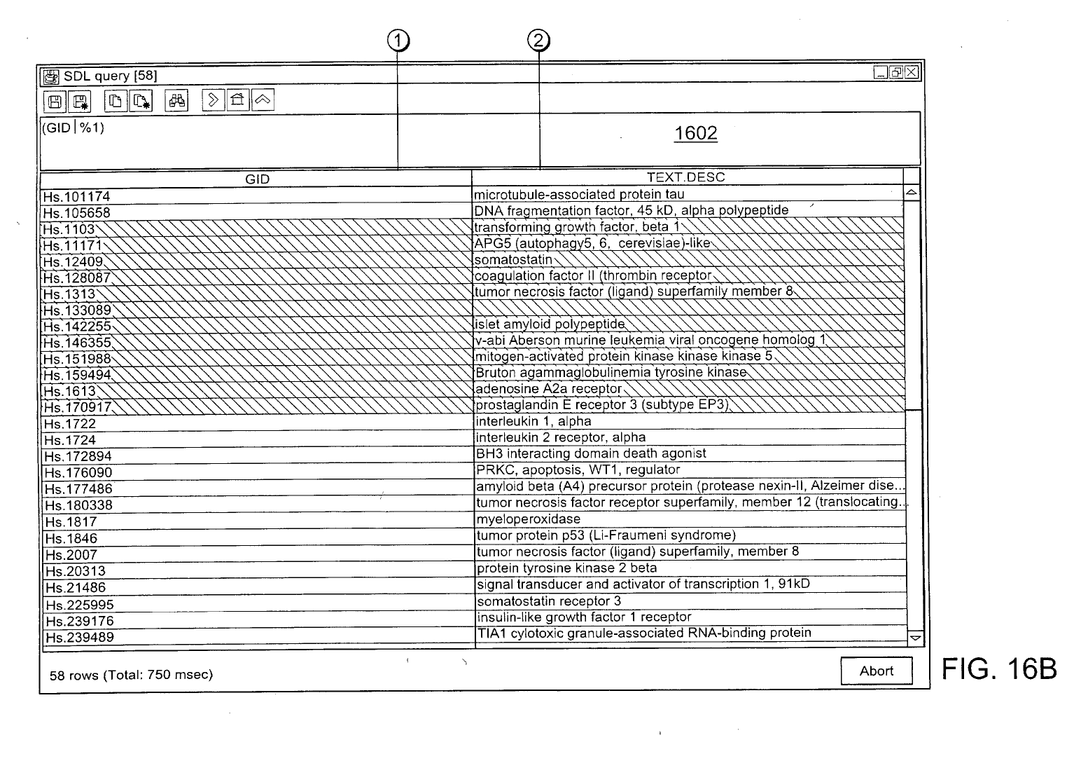

The composite query-tool provides a very simple mechanism to specify a report for the elements in the query sets. FIG. 16 shows the report output-specification in the preferred embodiment. Actually, the output-specification tool is a relation definition tool and the relations generated with it could be registered in the SDL system metadata. However, in the present invention, applicants only consider it for the purpose of generation relations that can be joined with the SDL query sets, in order to provide more information on the elements in the sets. The output-specification tool provides drag-and-drop support and the user selects the dimensions he wants to see together, e.g. GID and TEXT.DESC 1600 (FIG. 16A), and places them in the report, 1601. By a mouse double-click on any set in the list-box, 1206 (FIG. 12A), a report corresponding to the set and the output-spec opens up, 1602 (FIG. 16B).

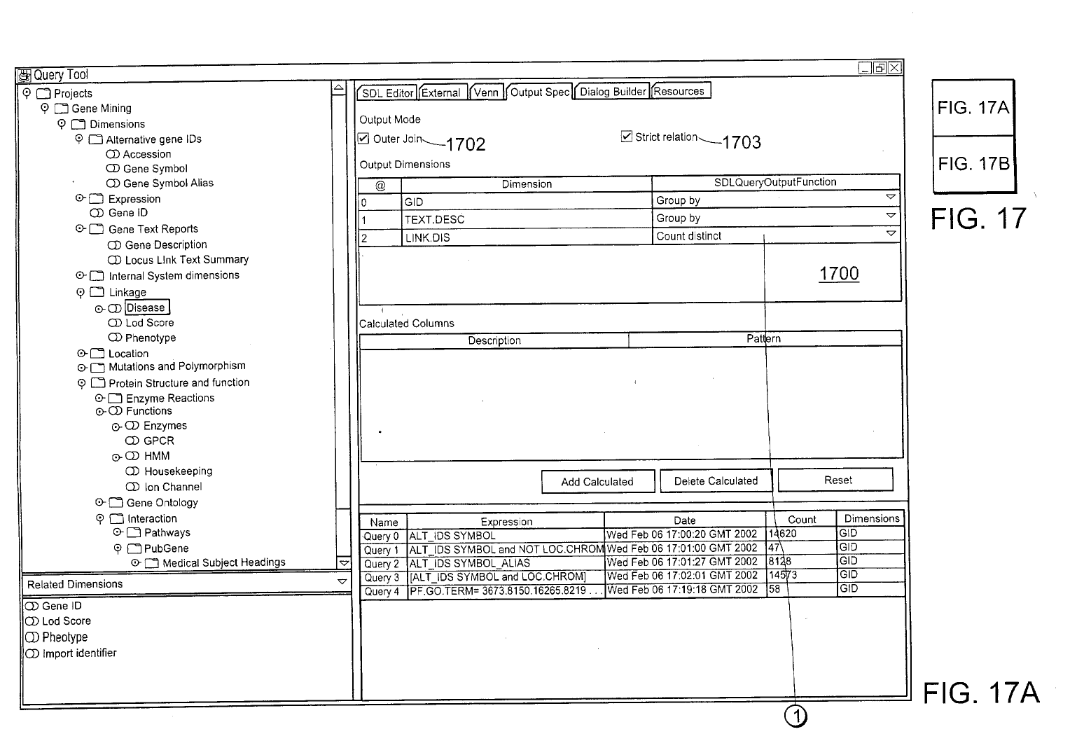

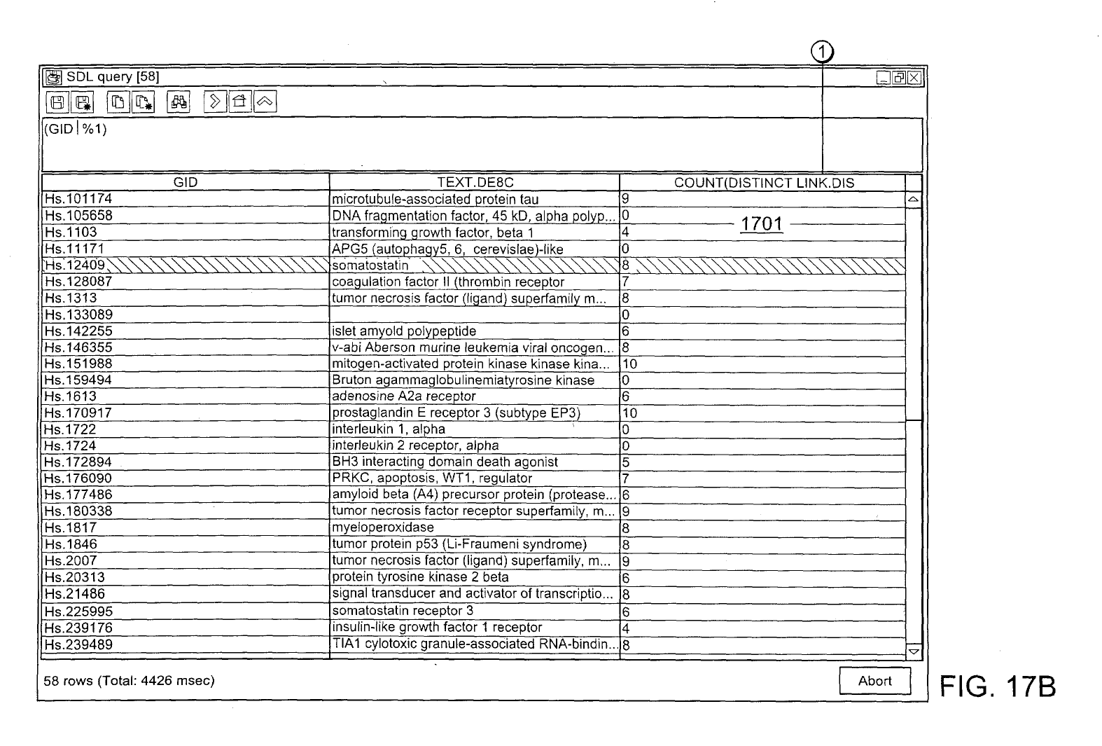

As shown in FIGS. 17A and 17B the output-specification also supports the creation of columns with aggregate operators 1700 (the standard SQL aggregate operators) as shown in 1701 (FIG. 17B). Furthermore, the output-specification tool allows the user to specify whether the relations that contain the dimensions should be joined with the set using outer-join or regular join 1702. Also, it allows the user to specify if all the dimensions in the report have to come from a single relation or not. If strict is selected 1703 the system will complain if more than one relation is needed to cover all the dimensions specified in the output-specification. Notice that the output-specification is to specify an operation, i.e. the report generation, that is totally independent of the SDL set definition.

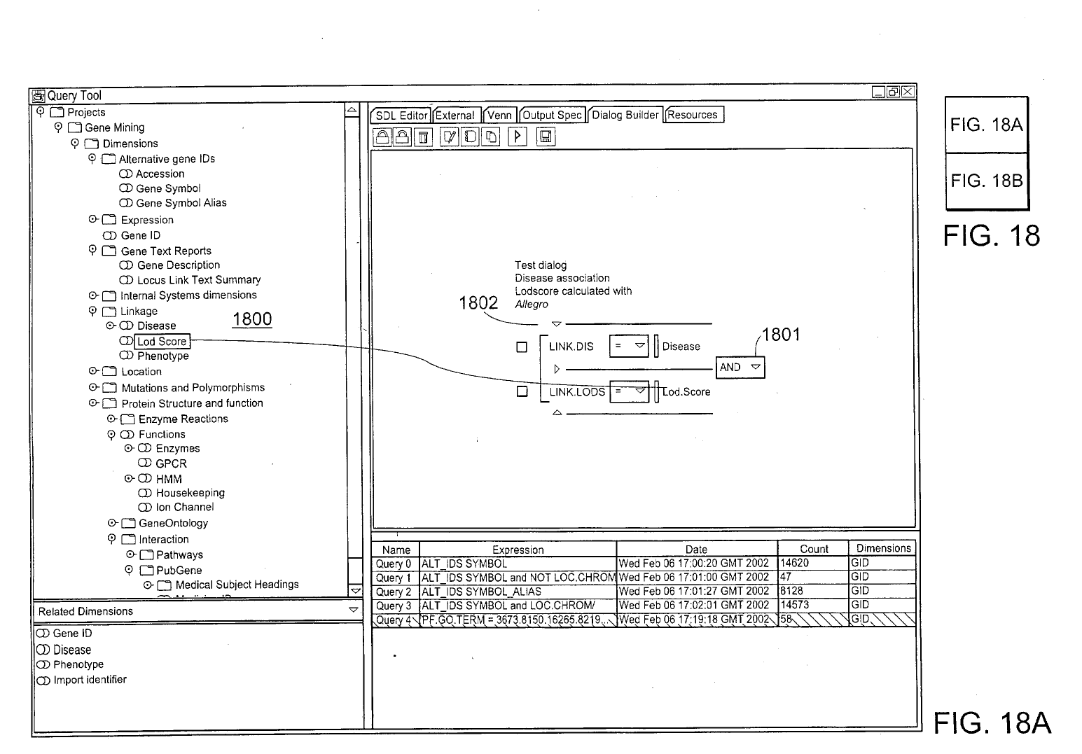

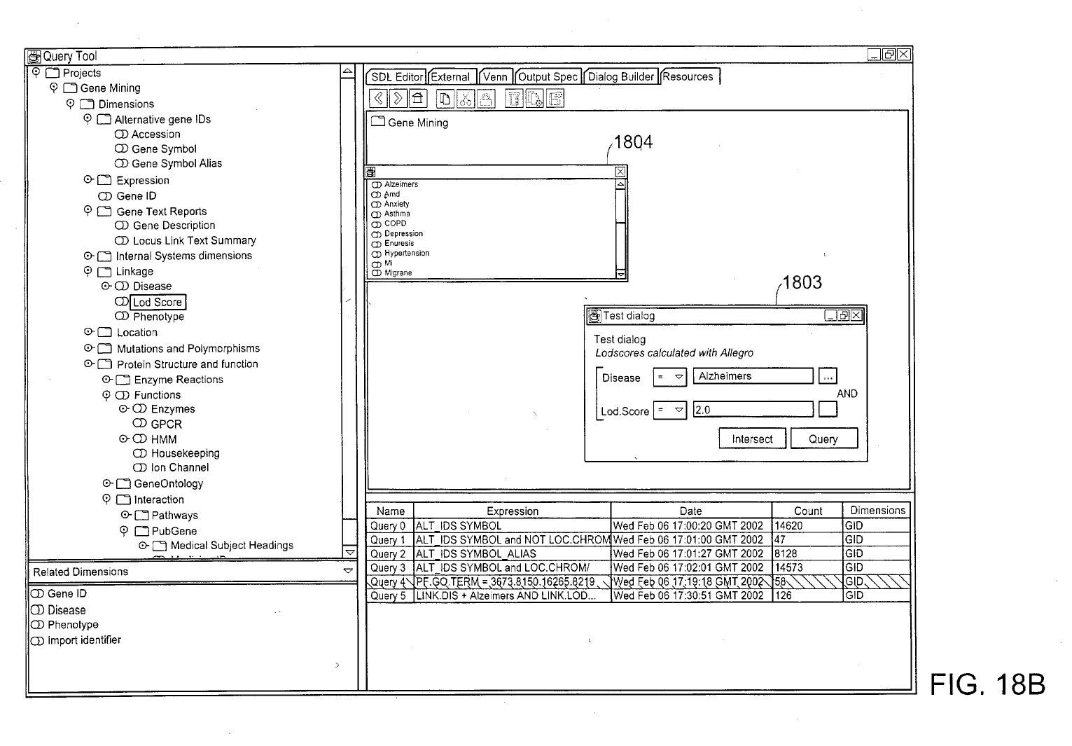

Even though the syntax-aware editor in conjunction with the drag-and-drop behaviour of the metadata tree provides a userfriendly interface, it is even easier to issue queries through specially designed dialogs. Because of the simple and sparse nature of the SDL language, it is relatively easy to create a drag-and-drop driven dialog builder in which users can create their own dialogs without any programming effort. In the preferred embodiment of the composite query tool, applicants describe a dialog builder as shown in FIGS. 18A and 18B. The user can simply drag the dimensions from tree, 1800 (FIG. 18A), and drop them onto a canvas. This will create an input-field for the corresponding dimensions in the dialog. The user can then build expressions with Boolean logic by connecting the input-fields with either AND or OR as in 1801. Furthermore, the user can enclose input-fields from the same relation into a record-operator by labeling the appropriate dimensions with a tick-mark and then locking them together 1802.

The dialogs can be locked and launched such as from the “resources” tab. The dialog then prompts the user for input 1803 (FIG. 18B) for all the fields in the dialogs. The inputs will then become constraints on the corresponding dimensions, e.g. disease of lodscore in 1803. For enumerable dimensions the dialog even supports browsing of the corresponding domain hierarchy 1804. Once the user presses the query button in the dialog, an SDL query is launched and the result set appears in the list-box 1501 (FIG. 15A), like the sets defined from the editor. A particularly nice feature of the dialogs in the preferred embodiment is that if the user does not complete all fields, the dialog will generate a reduced expression. The rules resemble the way NULL is treated in Boolean logic in SQL, e.g. expression {e1 AND unknown AND e3} will become {e1 AND e3} and {e1 AND unknown OR e3} will become {e1 OR e3}. Since the expressions that the dialogs support are relatively simple SDL expressions, e.g. no brackets nor nested sets are supported, the reduction of the expression based on undefined fields does not cause confusion. In many ways the dialogs can be considered as SDL setnames (formulas) with parameters (see the SDL syntax specification). Indeed, the present embodiment stores setname-formulas and dialogs in a similar manner.

The “SDL Users Manual” is attached as an appendix to the related U.S. Provisional Application No. 60/356,559 and provides further description of Applicants' overall SDL system and the present invention SDL server 102. Such description is herein incorporated by reference as part of this disclosure.

While this invention has been particularly shown and described with references to preferred embodiments thereof, it will be understood by those skilled in the art that various changes in form and details may be made therein without departing from the scope of the invention encompassed by the appended claims.

What is claimed is:

1. In a computer system, a method of defining sets of data to be retrieved from a data store, comprising the steps of:
providing a written representation of a desired data set in terms of dimensions and relation instances, the desired data set having a certain set type; and
implying constraints on relation instances or dimensions by one of the set type of the desired data set and a record operator, said step of implying constraints enabling length of the written representation to be minimized.

2. A method as claimed in claim 1 wherein the step of providing a written representation includes employing any combination of a disjunctive expression and a conjunctive expression; and
further comprising the steps of:
performing OR-distribution on disjunctive expressions; and
eliminating from disjunctive expressions, conjuncts with undefined binding variables.

3. A method as claimed in claim 1 wherein the step of providing a written representation includes employing any combination of disjunctive expressions and conjunctive expressions; and
further comprising the steps of:
translating conjunctive expressions to respective SQL join terms; and
translating disjunctive expressions to respective SQL-union terms.

4. A method as claimed in claim 3 further comprising the step of rewriting the disjunctive and/or conjunctive expressions such that the SQL union operator is applied after the SQL join terms are calculated, resulting in a computationally faster implementation.

5. A method as claimed in claim 1 further comprising the step of automatically enforcing a record-operator where an expression in the written representation without the record-operator is equivalent to the expression with the record-operator.

6. A method as claimed in claim I wherein the step of providing a written representation includes employing an IN-statement and a disjunctive expression in a nested set; and
further comprising the step of applying OR-distribution within the nested set by treating the IN-statement effectively as a record-operator expression.

7. A method as claimed in claim I wherein the data store has a native query engine; and
further comprising the step of rewriting the written representation such that upon translation of the rewritten written representation into code for the native query engine, the code is optimized for querying the data store.

8. A method as claimed in claim I wherein the step of providing a written representation includes utilizing a certain symbol to specify hierarchical constraints on dimensions.

9. A method as claimed in claim 8 wherein the certain symbol is a colon.

10. A method as claimed in claim 1 wherein the step of providing a written representation includes utilizing any combination of AND and OR expressions; and
further comprising the step of performing OR-distribution in a manner that results in expressions with different sets of dimensions.

11. A method as claimed in claim 1 further comprising the step of grouping expressions from the written representation, based on record operator constraint.

12. In a computer system, apparatus for defining sets of data to be retrieved from a data store, comprising:
an input component for providing a written representation of a desired data set in terms of dimensions and relation instances, the desired data set having a certain set type; and
an assembly coupled to receive the written representation, in response the assembly implying constraints on relation instances or dimensions by one of the set type of the desired data set and a record operator, said implying constraints enabling length of the written representation to be minimized.

13. Apparatus as claimed in claim 12 wherein the written representation includes any combination of a disjunctive expression and a conjunctive expression; and
the assembly further performs OR-distribution on disjunctive expressions and eliminates from disjunctive expressions, conjuncts with undefined binding variables.

14. Apparatus as claimed in claim 12 wherein the written representation includes any combination of disjunctive expressions and conjunctive expressions; and
the assembly translates conjunctive expressions to respective SQL join terms and disjunctive expressions to respective SQL-union terms.

15. Apparatus as claimed in claim 14 wherein the assembly rewrites the disjunctive and/or conjunctive expressions such that the SQL union operator is applied after the SQL join terms are calculated, resulting in a computationally faster implementation.

16. Apparatus as claimed in claim 12 wherein the assembly automatically enforces a record-operator where an expression in the written representation without the record-operator is equivalent to the expression with the record-operator.

17. Apparatus as claimed in claim 12 wherein the written representation includes an IN-statement and a disjunctive expression in a nested set; and
the assembly applies OR-distribution within the nested set by treating the IN-statement effectively as a record-operator expression.

18. Apparatus as claimed in claim 12 wherein the data store has a native query engine; and
the assembly further translates the written representation into code for the native query engine in a manner such that the code is optimized for querying the data store.

19. Apparatus as claimed in claim 12 wherein the written representation utilizes a certain symbol to specify hierarchical constraints on dimensions.

20. Apparatus as claimed in claim 19 wherein the certain symbol is a colon.

21. Apparatus as claimed in claim 12 wherein:
the written representation includes any combination of AND and OR expressions; and
the assembly optionally performs OR-distribution in a manner that results in expressions with different sets of dimensions.

22. Apparatus as claimed in claim 12 wherein the assembly groups expressions from the written representation based on record operator constraint.

23. Apparatus as claimed in claim 12 wherein the input component includes:
an editor for composing written representations; and
a search engine for enabling user browsing of dimension values and relations of the data store, to assist a user in composing desired written representations.

24. Apparatus as claimed in claim 23 wherein the search engine provides graphical views of dimension hierarchies for user browsing.

25. Apparatus as claimed in claim 23 wherein the editor employs a user interface which supports drag and drop of dimensions and relation values in written representations being composed.
